(19) United States
(12) Patent Application Publication
(10) Pub. No.: US 2019/0204430 A1
(43) Pub. Date: Jul. 4, 2019

(54) Submerged Vehicle Localization System and Method

(71) Applicant: Woods Hole Oceanographic Institution, Woods Hole, MA (US)

(72) Inventors: Henrick SCHMIDT, Norfolk, MA (US); Nicholas R. Rypkema, Cambridge, MA (US); Erin Fischell, East Falmouth, MA (US)

(21) Appl. No.: 16/237,463

(22) Filed: Dec. 31, 2018

Related U.S. Application Data
(60) Provisional application No. 62/612,520, filed on Dec. 31, 2017.

(51) Int. Cl. G01S 11/14; H04B 13/02

(52) U.S. Cl. CPC G01S 11/14; H04B 13/02

(57) ABSTRACT

An inexpensive acoustic beacon-type system suitable for the self-localization of one or more submergable secondary vehicles such as AUVs. A single beacon in a primary system periodically transmits an acoustic signal to the secondary vehicle. The acoustic signal is passively received by at least two receivers such as an AUV-mounted ultra-short baseline (USBL) array, which enables multiple vehicles to localize using just a single beacon. A controller (i) maintains time-synchronization with the primary system, (ii) develops a range estimate signal from measurements of received signals from at least two receivers and (iii) develops an azimuth-inclination estimation of likeliest angle-of-arrival of the primary signals, wherein the controller utilizes a plurality of coordinate frames to provide an estimate of secondary system location.

### CROSS-REFERENCE TO RELATED APPLICATION

This application claims priority to U.S. Provisional Application No. 62/612,520 filed Dec. 31, 2017, the contents of which are hereby incorporated as if set forth herein in its entirety.

### STATEMENT REGARDING GOVERNMENT LICENSE RIGHTS

This invention was made with U.S. Government support under N00014-16-1-2081 awarded by the Office of Naval Research. The U.S. Government has certain rights in this invention.

### FIELD OF THE INVENTION

This invention relates to determining the location of submerged vehicles. More particularly to one-way transmission of time-synchronized signals and real-time processing to facilitate low-cost self-navigation within a liquid body.

### BACKGROUND OF THE INVENTION

Precise locational information is critical for practically any autonomous vehicle, robot, or other object. Location-determining solutions for terrestrial vehicles exist, including GPS positioning. However, GPS signals does not penetrate into liquid bodies (e.g. the ocean), and submerged vehicles must rely on other methods to determine their precise location. Underwater positing systems have been developed, but these have major drawbacks, relying either on multiple stationary acoustic beacons, or large and power-hungry devices systems.

U.S. Pat. No 5,894,450 describes an underwater location solution utilizing Long Baseline (LBL) acoustic positioning systems first developed in the 1960s. LBL-based systems require multiple, moored transmitters, each emitting signals into the environment in order for submerged vehicles to receive the signals and triangulate their position. LBL transmitters are fixed in a single location and any transmitter movement would make the system inoperable. Also, the reliance on multiple transmitters increases the acoustic noise of the system, making signal measurement and calculation by the receiving vehicle error-prone, decreasing the fidelity of the system. Furthermore, LBL systems typically require two-way time-travel (TWTT).

Underwater and oceanographic activities usually take place in large and complex liquid environments. Typical marine environments are the open ocean, littoral (near shore), reefs, bays, island areas, straits, seas, gulfs, shipping lanes, harbors, canals, reservoirs, lakes, rivers and even liquid handling plants. The local terrain in any of these environments can be very complex, and any vehicle operating in such an environment must know its location in order to effectively carry out its desired operation. Current underwater localization methods are costly, large and power hungry (i.e. requiring significant power supplies); thus increasing the size and expense of an underwater vehicle incorporating such a system. Therefore, there is a need for a low cost, electrically efficient submersible positioning system. Such a system is described herein. Such a low-cost system would increase the use of autonomous underwater vehicles (AUVs) in many underwater activates, including surveying, patrolling, search and rescue, environmental monitoring, and scientific exploration, sampling, and measuring.

Furthermore, in order to provide a complete picture or report of the desired underwater activity, it is essential for an AUV to cover all or most of a region of interest. Due to size, weight and cost constraints for small AUVs, and the physical complexity and characteristics of the underwater environment, a single AUV can only record a limited amount of data with its on-board instrumentation, requiring more time and movements to cover the desired area. One way to expand the volume of coverage, is to use more than one AUV, often in a pre-selected formation, where each AUV covers a small portion of the overall coverage area surveyed by the AUV formation.

AUV formations or networks greatly expand the activities AUVs can efficiently and effectivity perform. However, there are significant practice challenges to the use of AUV formations in submerged environments. Larger submergible vehicles such as submarines and large AUVs have specialized, high quality navigation systems, but larger vehicles are costly, not well adapted for use in formations, and require substantial support capabilities between missions.

Small, inexpensive AUVs, while well adapted for use in formations, cannot utilize the large, heavy, costly and power-hungry navigation systems of larger AUVs. Therefore, small AUVs experience significant navigation errors, which accumulate rapidly, on the order of tens of meters per minute. These navigation errors present a significant hurdle for the use of small AUVs in formation or networked activities.

Recently, Fischell et al. proposed a technique in “Relative Acoustic Navigation for Sensing with Low-Cost AUVs”, IEEE IRCA 2016 Workshop on Marine Robot Localization and Navigation and “Design of General Autonomy Payload for Low-Cost AUV R&D” (Viquez et al.

IEEE Autonomous Underwater Vehicles, p. 151-155, 2016), both incorporated by reference herein. That technique utilized a pulse per second signal from a GPS-synchronized CSAC (chip scale atomic clock) transmitter. Fischell et al. discloses a fixed-source transmitter, but suggest that a mobile-source may be possible. However, their method only achieved low-quality results with unacceptably large errors in estimated range and bearing to a fixed acoustic source, and was only possible in a non-real-time manner. A mobile-source utilizing this method would have had even greater range and bearing error.

It is therefore desirable to enhance accurate navigation for AUVs by utilizing an innovative strategy of precision signal sensing, timing and processing to overcome the aforementioned navigation, sensing and control issues.

### SUMMARY OF THE INVENTION

An object of the present invention is to enable low-cost yet accurate localization by one or more secondary vehicles within a liquid body relative to a single source of time-synchronized acoustic signals.

Another object of the present invention is to enable use of only a single primary acoustic sound system, either fixed or on a motile primary vehicle, to reduce secondary vehicle complexity, weight and power consumption.

A still further object of the present invention is to enable scalable secondary vehicle numbers without requiring time or frequency sharing of the transmitted signal.

This invention features a localization system for at least one vehicle within a liquid body, the localization system including a primary system, also referred to herein as a source system and/or a master system, having a first positioning module configured to determine a location of the primary system. The primary system further includes a signal generation and timing unit that generates periodic timed primary signals, and a submergible transmitter to transmit the primary signals, such as acoustic signals, through the liquid body. The localization system further includes at least one secondary system that is carried by the vehicle and includes at least two receivers to receive the primary signals and a controller that (i) maintains time-synchronization with the primary system, (ii) develops a range estimate signal from measurements of received signals from each receiver and (iii) develops an azimuth-inclination estimation of likeliest angle-of arrival of the primary signals. The controller utilizes a plurality of coordinate frames, such as particle filter coordinate frames, to provide an estimate of vehicle location.

In certain embodiments, the estimate of vehicle location is relative to the location of the primary system. In some embodiments, the controller applies a beamformer to a first plurality of look-angles and the received primary signal, each look-angle representing a combination of azimuth and inclination vectors, generating a first plurality of corresponding outputs, each output having a power, and the controller selects the output with the maximum power, representing approximately the azimuth and inclination between the primary system and secondary system. In a number of embodiments, the first plurality of look-angles is constrained to a second plurality of look-angles by the controller applying a particle filter, said second plurality having a smaller number of look-angles than the number of look-angles in the first plurality. In some embodiments, the controller further comprises a spatial filter stored in a computer-readable storage medium, the spatial filter comprising phase-shifts associated with a regular grid of a third plurality of look-angles. The secondary system further comprises a second positioning module, configured to determine the location of the secondary system, and the controller re-initiates the first plurality of look-angles upon said second positioning module determining the location of the secondary system. The first plurality of look-angles is converted to a fourth plurality of look-angles based on a motion model, the motion model estimating vehicle speed and yaw. The fourth plurality of look-angles is constrained to a fifth plurality of look angles by the controller applying a particle filter, said fifth plurality having a smaller number of look-angles than the number of look-angles in the fourth plurality.

In certain embodiments, the primary signals are generated to further include information encoding at least one of primary system location, and at least one command to the at least one secondary system. The signal generation and timing unit further generates periodic secondary signals which comprise information encoding at least one of primary system location, and at least one command to the at least one secondary system. In one embodiment, the location system further includes at least a second primary system which comprises a third positioning module configured to determine a location of said second primary system, a second signal generation and timing unit that generates periodic timed second primary signals, and a second submersible transmitter to transmit the second primary signals through the liquid body. The primary signals have a first waveform and the second primary signals have a second waveform, and the at least two receivers receive said second primary signals. The at least one secondary vehicle is configured to achieve self-localization to within one meter accuracy.

In one embodiment, phased-array beamforming is conducted by iterating various azimuth-inclination look-angles, using array geometry to apply time-delay phase shifts to the received signals, and summing the time-delayed signals to determine a maximum response where the receiver/hydrophone signals are in phase and add constructively. In certain embodiments, phase shifts associated with each look-angle are precomputed and stored for use by the controller/beamforming and filtering module. In one embodiment, frequency domain operations are limited to a range of interest (e.g. 6-10 kHz). Certain embodiments generate heatmap of azimuth-inclination combinations.

In some embodiments, the particle filter coordinate frames utilized by the controller include at least two of a body-fixed frame, a vehicle-carried frame, and a local-level frame. In some embodiments, the controller transforms local-level particles to obtain vehicle-carried particles, and calculates particle magnitudes to obtain range-line particles. In certain embodiments, the controller re-initializes particles when a locational fix (e.g. GPS signal) is received. In some embodiments, a location prediction step includes sorting a vehicle-carried particle set and a range-line particle set in ascending order according to their weights.

In a number of embodiments, the controller further includes a factor graph smoothing module to optimize location estimations over a trajectory of the vehicle. In some embodiments, the vehicle further includes a propulsion system and a power source

This invention also features a localization system for a plurality of vehicles within a liquid body. A primary source system includes a positioning module, a signal generation and timing unit that generates periodic timed primary signals, and a submergible transmitter to transmit the primary signals through the liquid body. Each vehicle includes (i) at least two receivers such as a hydrophone array to receive the primary signals, (ii) a data acquisition module that maintains time-synchronization with the primary source system to trigger periodic recordings from the receivers, (iii) a beamforming and matched filtering module that develops a range estimate signal from measurements of received primary signals from each receiver and develops an azimuth-inclination estimation of likeliest angle-of arrival of the primary signals, and (iv) a particle filtering module utilizing a plurality of coordinate frames to provide an estimate of vehicle location.

This invention further features a method for locating at least one submersible vehicle, including selecting at least one primary system including a first positioning module, a signal generation and timing unit configured to generates periodic timed primary signals, and a submersible transmitter to transmit the primary signals. The method further includes selecting the at least one submersible vehicle to carry at least one secondary system including at least two receivers to receive the primary signals, and a controller. The location of the at least one primary system is obtained utilizing the first positioning module. At least one primary signal is sent from the at least one primary system, and time-synchronization is maintained between the at least one primary system and at least one secondary system. The at least one primary signal is received utilizing the at least two receivers of the at least one secondary system. An azimuth-inclination estimation of likeliest angle-of arrival of the received primary signal is developed, and a plurality of coordinate frames are utilized to estimate range and secondary location relative to the at least one primary system.

This invention may also be expressed as a method performed by a vehicle having at least one computer processor executing computer program instructions stored on at least one non-transitory computer-readable medium to accomplish the method as described herein. This invention may be further expressed as a vehicle having a non-transitory computer-readable medium storing computer program instructions to accomplish the method as described herein. This invention may be still further expressed as a system including at least one vehicle having at least one computer processor, at least one non-transitory computer-readable medium operatively connected to the computer processor, and memory accessible by the processor. Responsive to execution of program instructions accessible to the at least one processor, the at least one processor is configured to accomplish the method described herein.

### BRIEF DESCRIPTION OF THE DRAWINGS

In what follows, preferred embodiments of the invention are explained in more detail with reference to the drawings, in which:

FIG. 1A is a schematic block diagram representing a system according to the present invention having a primary system including an acoustic beacon and an secondary system capable of self-navigation according to the present invention;

FIG. 1B is a schematic illustration of a primary vehicle having an acoustic source system generating signals received and processed by a plurality of AUVs according to one aspect of the present invention;

FIG. 2A is a schematic graph representing magnitude frequency response of an up-chirp signal emitted by the primary acoustic source system of FIG. 1B;

FIGS. 2B and 2C are in-water spectrographs of up-chirp received and recorded by the secondary AUV of FIG. 1B;

FIGS. 2D-2G are schematic time-frequency in-water spectrograms of LFM signals broadcast by a primary system according to two embodiments, with FIGS. 2D and 2F illustrating a signal transmitted for 20 ms, at 7-9 kHz and FIGS. 2F and 2G illustrating a signal transmitted for 20 ms, at 16-18 kHz;

FIG. 3 is a schematic side partial cross-sectional view of a Bluefm SandShark AUV modified according to the present invention;

FIG. 4A is a schematic illustration of the Sequential Monte-Carlo beamforming system according to one embodiment, including signal reception, signal processing and secondary vehicle movement considerations;

FIGS. 4B-4D are schematic charts of time sequential matched filtering outputs;

FIGS. 4E and 4F are conceptual illustrations of phased-array beamforming, with FIG. 4E showing beamformer power output is small when the canidate look-angle is pointing away from the incoming signal, and FIG. 4F showing received signals add constructively when the canidate look-angle is correct, resulting in high beamformer power output;

FIGS. 5A and 5B are schematic charts of a typical heatmap resulting from phased-array beamforming according to the present invention, as well as azimuth-inclination “particles” in the body-fixed frame with spherical coordinates;

FIG. 5C is a schematic three-dimensional representation of azimuth-inclination particles in the vehicle-carried frame, and current vehicle attitude;

FIG. 5D is a schematic graph showing typical range estimate signal resulting from matched filtering, as well as a histogram of range particles on the range-line;

FIGS. 5E and 5F are schematic three-dimensional representations of beamforming in the range-normalized AUV forward-port-up body-fixed frame, with FIG. 5E depicting finding the likeliest angle to the beacon corresponds to an exhaustive search for the maximum power output over a grid of look-angles that covers the surface of the unit sphere (using 7200 look-angles), and FIG. 5F showing that particles in the sequential Monte-Carlo beamformer use vehicle motion model to limit the search space to the area of the surface containing the global maximum (using only 1500 look-angles);

FIG. 5G is a schematic graph of combined azimuth-inclination and range particles (dots) in the local-level frame, as well as particle filter estimated AUV trajectory (lines);

FIG. 5H illustrates the transformations back and forth between the body-fixed frame (bff) of FIGS. 5A and 5B and the vehicle-carried ENU frame (vcf) of FIG. 5C;

FIG. 5I illustrates the transformation between the vehicle-carried ENU frame (vcf) of FIG. 5C and the local level ENU frame (llf) of FIG. 5G;

FIG. 5J illustrates the transformation between the local level ENU frame (llf) of FIG. 5G and the range line (rl) of FIG. 5D;

FIG. 6 is a schematic illustration of a factor graph, illustrating secondary vehicle poses connected by motion model odometry (“odo”) and primary (beacon) pose connected to vehicle poses by either azimuth-range or range-only measurements;

FIGS. 7A-7C represent Run 1 and FIGS. 7D-7F represent Run 2, with FIGS. 7A and 7D being azimuth estimates and FIGS. 7B and 7E being range estimates to beacon (i.e. primary) in body-fixed frame, including dead-reckoned, particle filter output and raw acoustic measurement maxima, with vertical lines indicating GPS fix times, and FIGS. 7C and 7F depicting AUV trajectory estimates in local-level frame including dead-reckoned, particle filter output and iSAM2 factor graph smoothing, with dashed circles indicating GPS fix locations;

FIG. 8A-8D depict schematic closed-loop SandShark trajectory estimates, illustrated with piUSBL beacon position, LBL transponder positions, and AUV GPS surfacing positions, with FIGS. 8A and 8B showing piUSBL trajectory estimates with line shading indicating mission time for run 3 (FIG. 8A) and run 4 (FIG. 8B), and FIGS. 8C and 8D depicting dead-reckoned trajectory estimates with line shading indicating mission time for run 3 (FIG. 8C) and run 4 (FIG. 8D);

FIG. 9A-9B depict Runs 3 and 4, respectively, with ranges to LBL transponder (XPNDR) 1 and 2 calculated from trajectory estimates—ranges to transponder 1 and 2 for piUSBL trajectory, for dead-reckoned trajectory, and for commercial LBL raw values;

FIG. 10A-10B depict Runs 3 and 4, respectively, showing error statistics for piUSBL and dead-reckoned (DR) trajectory estimates when compared to the independent commercial LBL system;

FIG. 11 shows SandShark dead-reckoned trajectory for relative navigation mission with beacon homing and loitering. Progressively darkening solid-line trajectory is AUV internal odometry, and dots-on-a-line are a primary kayak and beacon GPS trajectory, with gradients indicating mission time and circles 855(a)-855(d) indicate visual confirmation of the beacon during flybys;

FIGS. 12A-12B are estimated relative range and azimuth, respectively, from the AUV to the moving beacon—the real-time on-board piUSBL filter estimate is plotted in solid lines, and offline arg-maximums for range and azimuth found through exhaustive search are overlaid as circles;

FIGS. 13A-13G are illustrative representations of pre-configured secondary vehicles behaviors according to one embodiment of the present invention;

FIGS. 14A-14D illustrate the coordinate reference frames utilized by the secondary vehicle and the SMC beamformer in accordance with one embodiment of the present invention;

FIG. 14E illustrates the transformation between the vehicle carried ENU local-level frame (llf) of FIG. 14A and the range domain of FIG. 14B;

FIG. 14F illustrates the transformation between the vehicle carried ENU local-level frame (llf) of FIG. 14A and the vehicle-carried ENU frame (vcf) of FIG. 14C; and

FIG. 14G illustrates the transformations back and forth between the vehicle-carried ENU frame (vcf) of FIG. 14C and the body-fixed frame (bff) of FIG. 14D.

### DETAILED DESCRIPTION OF THE PRESENTLY PREFERRED EMBODIMENTS

### Definitions

The term “AUV” is intended to include Autonomous Underwater Vehicles.

The term “ROV” is intended to include Remotely Operated Vehicles.

The term “UxV” is intended to include UAVs (Underwater Autonomous Vehicles or AUVs) and URVs (Underwater Remotely-operated Vehicles or ROVs).

The term “attitude” is intended to be given its ordinary meaning for navigation as a vertical angle from a horizontal plane to a reference node, also referred to as a reference point, a primary, a beacon, or an acoustic sound system according to the present invention.

The term “azimuth” is intended to be given its ordinary meaning for navigation as a horizontal angle measured clockwise from a reference node.

The terms “primary,” “acoustic source system” or “beacon” is intended to include any suitable system capable of producing an output that can be transmitted through a fluid to one or more secondary vehicles. One currently preferred acoustic source system comprises a Lubell amplifier and underwater speaker.

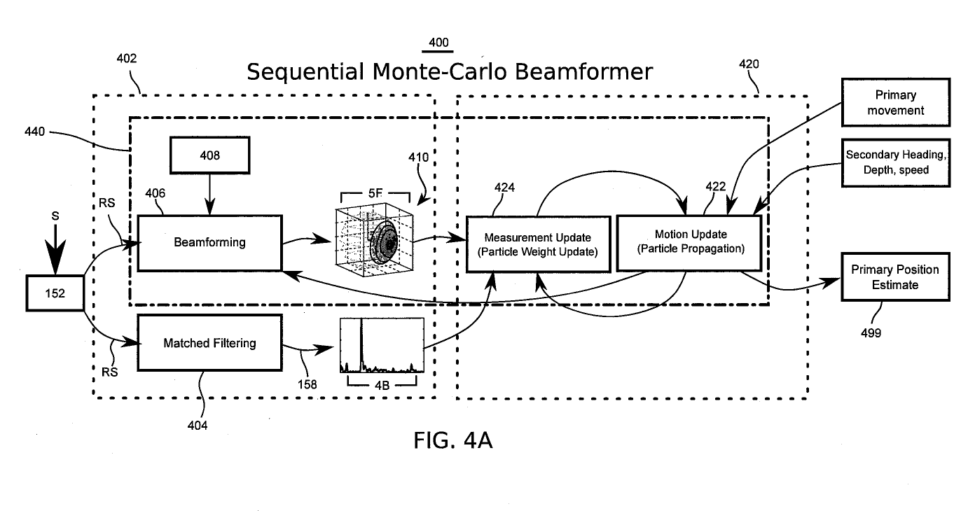

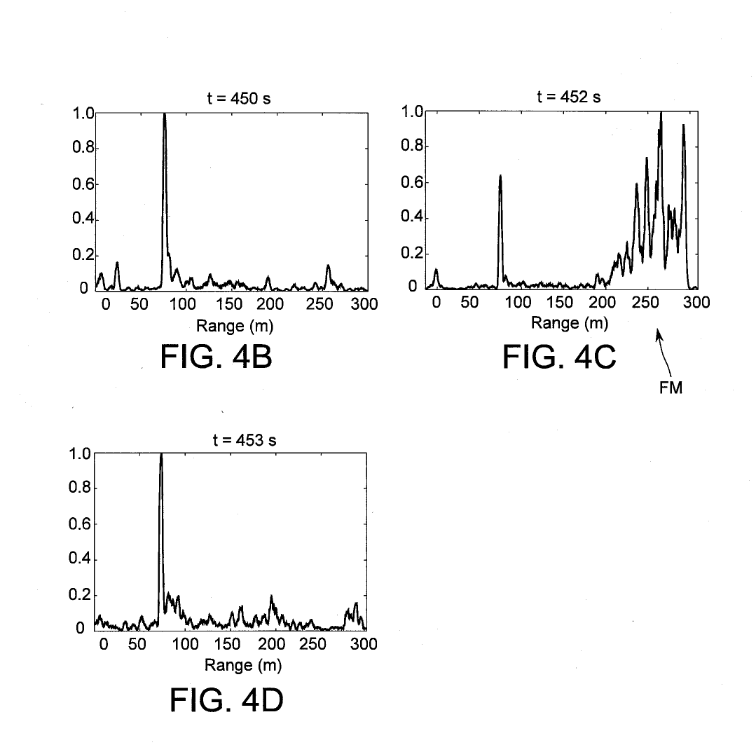

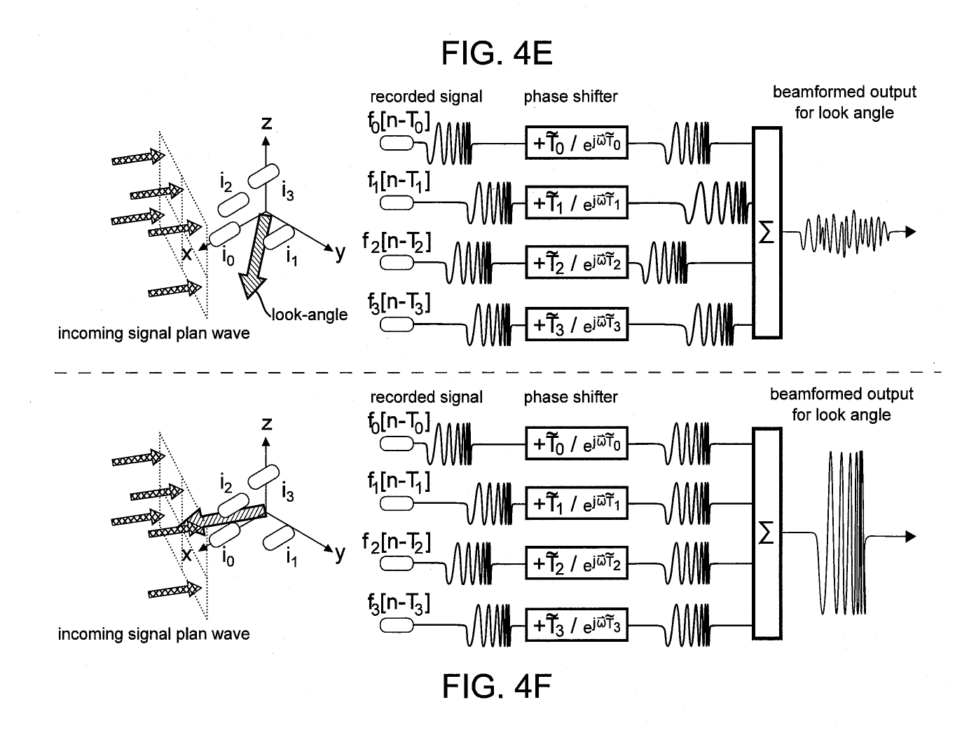

The term “beamforming” refers herein as a processing technique commonly used in sensor or receiver arrays for directional signal transmission or reception. Received signals from an array are combined, and the combination leads to interference between signals. When the signals are combined at the look-angle that represents the direction of the transmitter, the signals at that particular look-angle experience constructive interference, resulting in a larger output, as illustrated in FIGS. 4E and 4F.

The term “coordinate frame” as used herein refers to a system that uses numbers (i.e. coordinates) to uniquely determine a position in 3D space, with an origin set at a given point, usually the primary or a secondary. Each coordinate frame as disclosed herein has dimensions set relative to an origin, for example the origin being the secondary and the dimensions being forward of the secondary, port side of the secondary and above (towards the liquid body surface SS) the secondary, abbreviated Forward-port-Above, or bff.

The term “look-angle” as used herein refers to a combination of an azimuth vector and an inclination vector. The azimuth vector being the direction of a primary to a given secondary, expressed as the angular distance from the North point in a coordinate frame to the point at which a vertical circle passing through the primary intersects the horizon. The inclination vector being the secondary's tilt, as the difference between a reference plane and the primary plan or axis.

The term “DVL” is intended to include Doppler Velocity Logs.

The term “AHRS” is intended to include Attitude and Reference Systems.

The term “inertial navigation system” or “INS” is intended to include a navigation system that uses a computer, motion sensors, rotational sensors, and in some cases, magnetic sensors along with dead reckoning to continuously calculate the position, orientation and speed of a moving object without external references or input. Any suitable sensors can be used, including gyroscopes for object rotation, accelerometers for motion, and magnetometers for magnetics.

A “liquid body” refers to any structure, feature, or geographical formation capable of holding or retaining a liquid and the liquid contained therein. Examples of liquid bodies include but are not limited to, an ocean, bay, lake, river, reservoir, tank or pipe. The liquid can be any liquid, including water, saltwater, oil, liquefied gas, ethanol, wastewater, or the like. In this disclosure, the three-dimensional area of a liquid body may be referred to as a “medium,” a “liquid medium” or “multi-dimensional space”. The liquid bodies utilized by the invention are generally of a size and structure capable of simultaneously accommodating, in addition to the liquid, a primary and at least one secondary vehicle.

The term “locational fix” refers to the process of a component or vehicle that determines its location. Most often a locational fix is obtained by receiving a valid GPS position, with corresponding longitude and latitude coordinates (i.e. absolute location). A locational fix may be represented positional information by any means commonly known in the art, including laser positioning, DVL-INS systems, and reference mapping.

The term “inverted USBL” indicates that an acoustic array is carried by secondary vehicle instead of the primary acoustic source system.

The term “formation” includes any two or more vehicles or objects that move in relation with each other.

The term “submerged formation” refers to any formation of vehicles capable of diving into a suitable liquid, that is, to travel beneath the surface of a liquid body.

The term “self-localize” refers to the ability of a mobile object or vehicle to accurately determine its position in a medium in respect to a primary vehicle, without the aid of large, power hungry DVL, INS, AHRS, or other such systems.

The term “regular grid” refers to any three-dimensional grid, most often representing the surface of a sphere, of look angles. The look angles of the regular grid are selected and placed into a set and an equally spaced, which is separated by a regular distance between lines of the grid, arc degrees for spherical regular grids.

The term “offline” as used herein refers to a digital computational task that is performed at a time later than the signals or information is originally generated or received. Most often, offline refers to calculations performed later and on a different computing system than the system that originally received and stored the information. Offline calculations include the near instantons relaying of information from a first system to a second system, the second system performing the calculations and relaying the output back to the first system.

The term “low power” in this disclosure refers to the total power consumption of a mobile object without power-hungry systems like a DVL, AHRS and the like. Low power systems typically each require approximately 20 or less watts. Low power further refers to power consumption rates such that mission times are of sufficient length, and do not require vehicles with large power sources.

As referred in this disclosure, a “vehicle” is any controllable object that can physically move through the desired medium or liquid, including floating on top of the medium, or navigating through the medium (i.e. submerged). The vehicle can be any appropriate object, as commonly known in the art, including but not limited to a ship, boat, barge, or other human-occupied vehicle, AUV, ROV, UUV, submarine, or other submerged craft.

A “submerged vehicle” refers to any motile vehicle, vessel or device capable of being introduced into and operating within or on the liquid, or liquid body. Many submerged vehicles are commonly referred to as underwater vehicles, although they may operate in other liquids besides water. In this disclosure, a submerged vehicle includes, but is not limited to AUVs, drones, remotely operated vehicles (ROVs), unmanned underwater vehicles (UUVs), submarines manned or unmanned, amphibious vessels and the like.

### Overview

The system and methods described herein will now be described in more detail, with references to illustrative embodiments. The described features, advantages, and characteristics of the present invention may be combined in one of any suitable combinations, in one or more than one embodiment. One skilled in the relevant art will be aware that this invention may be practiced with or without one or more of the detailed features or advances present in any embodiment as described herein. In some instances, additional innovative features or advantages are recognized in particular embodiments that are not present in others. These illustrated embodiments, are for the purpose of describing the inventive system, features, and methodologies and are not to be understood to be limiting in any way.

The inventive system described herein pertains to submerged relative localization of a submerged vehicle, and formations of vehicles in a liquid body. Precise determination of a submerged vehicle's location is very important for many different underwater operations. When submerged vehicles operate as a group or team to complete a single mission, location information is even more important. In some constructions, submerged formations comprise at least two vehicles, either (i) a fixed primary or master signalling system, also referred to as simply the primary, and at least one secondary vehicle, or (ii) a motile primary vehicle and at least one secondary vehicle. In general, the primary obtains positional information by a method commonly known in the art, and transmits its positional information via a time-coordinated, time-stamped pulsed signal S (e.g. acoustic pulse). The secondary vehicle passively receives the signal pulse S with multiple receivers, analyzes the signal, and determines its own location relative to the primary.

This invention may be accomplished by a number of systems. In one currently preferred construction, a designated primary comprises a positioning module, a controller, a signal generation and timing unit, and a transmission mechanism. The system further comprises at least one secondary having a receiver mechanism, a controller, and a data acquisition module. Optionally, the secondary vehicle may further comprise an inertial measurement mechanism, a compass mechanism, and a depth sensing mechanism.

This invention includes innovative use of (a) one-way time travel (OWTT) of an inverted ultrashort baseline (iUSBL) signal from primary to secondary (b) passive reception of said OWTT signal by the secondary (piUSBL), and (c) precise position & orientation calculation via precise time synchronization, closely coupled particle filtering and beamforming.

The inventive submerged localization system described herein offers several important improvements over existing operations. The improvements include: 1) a single transmitter which is capable of being mobile, is carried by a motile primary, 2) low-power-consumption passive localization via OWTT and filtering and beamforming to accomplish ranging, azimuth and inclination to the primary, and 3) scalable secondary vehicle formations with non-interfering secondary receivers.

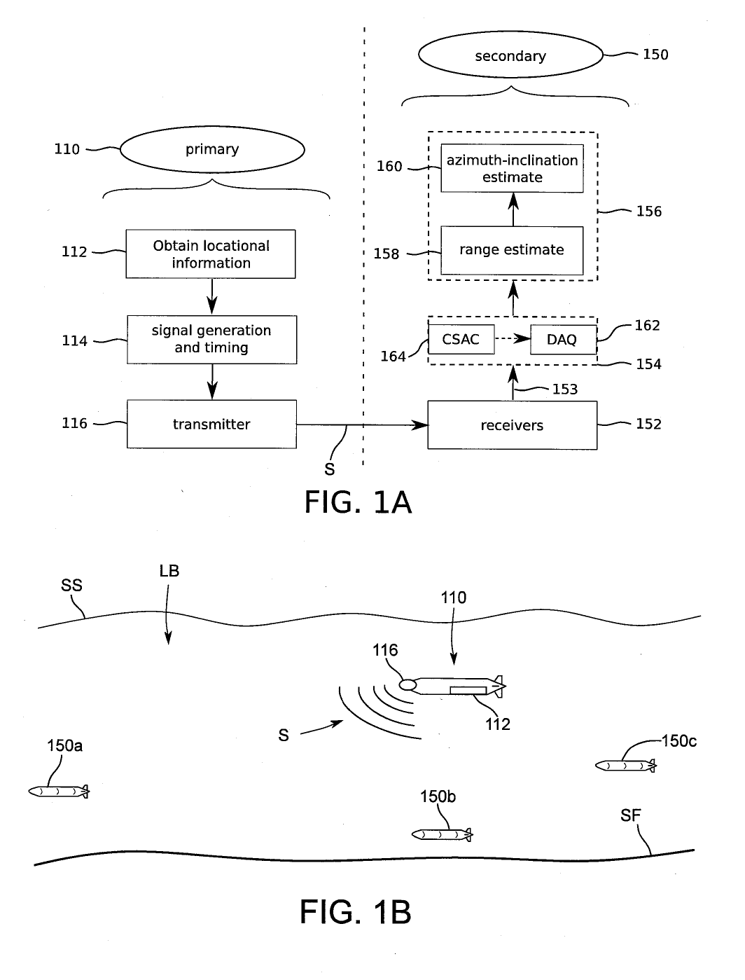

The primary 110, as illustrated in FIG. 1A, is configured to obtain positional information 112 (also referred to herein as “locational information”) by common methods, for example surface GPS fixes, and/or Doppler velocity log (DVL)-aided navigation, and to generate 114 and transmit 116 an underwater signal S (e.g. acoustic pulses). The secondary vehicle 150 is configured to receive the primary's signal S with the receiver mechanism 152, analyze the received signal RS with an interconnected digital controller 156 in relation with the synchronized timestamp 154 obtained from the timing mechanism 164, and to obtain precise relative location from range 158, azimuth and inclination 160 information.

Use of the innovative submerged formation system 100 according to the present invention is illustrated in FIG. 1B in a submerged environment having liquid body LB with a surface SS and a floor SF. A primary vehicle 110 carries at least one transmitter 116 that emits signals S and a positioning module (e.g. a DVL-INS) 112 that enables primary vehicle 110 to determine its position. The signals S emitted from transmitter 116 enable each secondary vehicle 150a-150c to determine their position relative to the primary vehicle 110.

### Primary System

The primary 110 further comprises a positioning mechanism 112 to accurately determine the position of the primary, a transmitter 116 that emits, or transmits a signal S into the liquid body LB and a controller 113. The positioning module 112 obtains positional information, often absolute position (e.g. GPS latitude and longitude). The controller 113 is connected to the position mechanism 112 and processes the positional information, and in turn programmatically generates a suitable signal S. The controller 113 instructs the transmitter 116 how and when to produce signal S. Furthermore, the timing systems of the primary and secondary are synchronized. Each mechanism in the master vehicle will be discussed in detail below.

### Signal

In order for the at least one secondary 150 to precisely determine its location relative to the primary 110, a signal S must be sent through the liquid body LB. The signal may be any suitable signal as known in the art, including acoustic, optical, and radio frequency, or other electromagnetic signals. In some embodiments, the primary 110 comprises more than one transmitter, each transmitter emitting a different signal mode (e.g. optical and acoustic signals).

The signal S typically comprises a pre-defined structure and timing. Known timing and time synchronizing between primary and secondary allows for precise estimation of range, azimuth and inclination by the secondary. The exact onset of the signal must be timed precisely, or the time-sensitive information contained within, and convey by, the signal would introduce significant errors, rendering the system inoperative. In one embodiment, the inventive system utilizes oscilloscope calibration and a hard-coded delay cycle to ensure a precise delay between the pulse per second (PPS) rising edge and the onset of signal. In the currently preferred embodiment, less than 1 millisecond of jitter (defined as slight irregular variation), less than 2 milliseconds of jitter, less than 3 milliseconds of jitter, less than 4 milliseconds of jitter, and less than 5 milliseconds of jitter is maintained between PPS rising edge and signal onset.

Utilizing an Arduino microcontroller is preferred to ensure extremely consistent (≤1 ms jitter) periodic transmission of the acoustic signal. The customizable nature of the primary and the signal generation according to the present invention enables broadcasting a variety of different signals as needed. In the currently preferred embodiiment, this is enabled by a wideband (200-2,300 Hz) frequency response of the transmitter (e.g. a Lubell underwater speaker). The underwater speaker and amplifier dominates the total cost of the primary, which could be reduced through the careful design and construction of a narrowband alternative. Furthermore, the primary is configured to customize the timing of the signal S, outputting the signal (e.g. a GPS up-chirp signal) at the start of every GPS second.

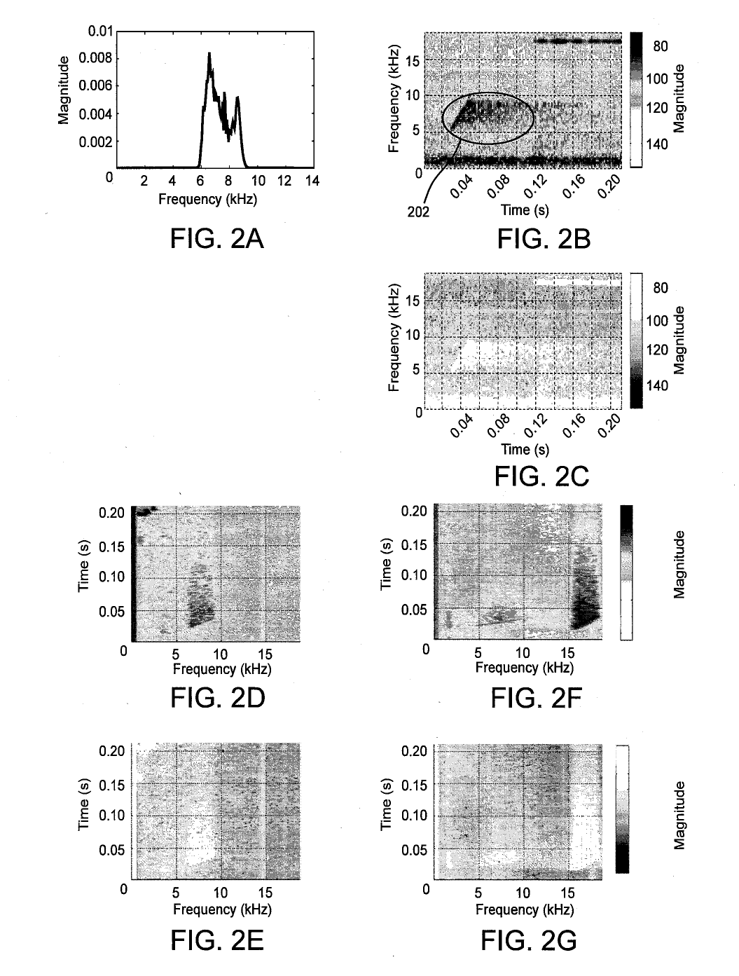

Known signal structure allow for proper identification of the signal from background noise by the secondary 150, as well as proper classification of the sections and properties of the signal S. Examples of acoustic signals S are illustrated in FIGS. 2A-2G. It is to be understood that additional information can be encoded into the signal after a known, predefined portion, for example after the initial up-chirp pulse 202 of approximately 0.1 s, additional acoustic data could be transmitted before the signal is repeated.

Additional information encoded in the signal S may be any desired information, most often updated primary location (e.g. a moving primary vehicle), new movement or measurement commands for secondary vehicles, or a subset of a plurality of secondary vehicles. In addition, the timing of the signals S is adaptable. Most often the signals are sent every second, in some cases the signals are sent every 0.1 seconds, 0.5 seconds, 2 seconds, 5 seconds, and every 10 seconds. Simple encoded commands may comprise instructions to the secondary vehicles' behaviour. For example, “follow”, “approach”, “circle”, “surface”, and/or execute pre-loaded programs (obtain sample, image, etc.) commands can be incorporated into the acoustic signal without affecting secondary localization. One technique for imparting more information into audio signals is described by Kira Coley in “The Dawn of High-Speed Underwater Communications”, Ocean News & Tech, October 2017, pp. 32-35. Other techniques and equipment for underwater acoustic communications are disclosed by Zhou et al. in U.S. Pat. No. 7,859,944, both publications are incorporated herein by reference

In the currently preferred embodiment, the signal S comprises an acoustic signal. The signal must be at least partially defined and known to the primary and secondary vehicles before deployment, such that the secondary vehicles accurately classify a recording correctly as a received signal RS. In one embodiment, depicted in FIGS. 2A-2C, an acoustic signal comprises an up-chirp signal h[n]. One possible signal as sent is depicted in FIG. 2A, and that signal as received by a secondary vehicle is displayed as an in-water spectrogram in FIGS. 2B-2C. Two additional signals are depicted in FIGS. 2D-2G and are described below in relation to Example 3. FIGS. 2D and 2E are schematic time-frequency in-water spectrograms of a LFM signals broadcast by a transmitter 116, comprising a 20 ms pluse (i.e. up-chirp) at 7-9 kHz and FIGS. 2F and 2G comprising a 20 ms pluse at 16-18 kHz.

### Secondary Vehicle

The present invention provides for one or more receiving systems 151 (e.g. a payload for a small AUV), often incorporated into a submersible vehicle 150 (e.g. a small AUV), comprising a receiver mechanism 152, to receive signals from the primary vehicle, and a controller 156 for maintaining time-synchronization, and calculating range, bearing, azimuth-inclination estimation, and, ultimately, secondary vehicle location.

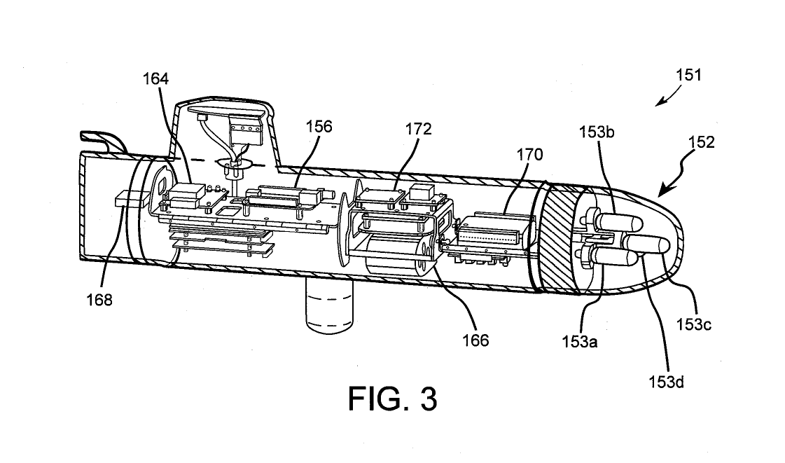

In one preferred embodiment, the secondary vehicle 150, as illustrated in FIG. 3, further comprises a separate time-synchronization mechanism (also referred to as a timing mechanism) 164, interconnected to an additional processing board, referred herein as a data acquisition module (DAQ) 162. The DAQ is then interconnected to the secondary controller 156, for processing the received acoustic signals as well as the precise time data.

In one currently preferred embodiment, the secondary vehicle 150 comprises an AUV, for example the Bluefin SandShark AUV, commercially available from General Dynamics. The payload 151 comprises approximately the front two third's of the vehicle 150 pictured in FIG. 3. The rear third of the vehicle is the standard SandShark platform (i.e. vehicle), which usually comprises a single magnetically-coupled propeller and motor, two stepper motors for elevator and rudder fin control, a pressure sensor for depth, a GPS and WiFi receiver, and a low-grade 9-axis MEMS IMU. Attitude and speed data is filtered from IMU and prop RPM and made available to the payload 151, which in turn uses this information to command AUV speed, heading, and depth using the MOOS-IvP autonomy software. The lack of DVL allows for the vehicle in this embodiment to be inexpensive and small, with about a 12.4 cm diameter and a total length of about 115 cm.

In another preferred embodiment, the secondary vehicle comprises a Hydromea Vertex AUV with an attached payload. The payload comprises a receiver mechanism 152, a low-grade IMU, a bearing mechanism (e.g. a compass), a controller, a timing mechanism and an optional depth sensing mechanism. Acoustic receiver equipment for underwater acoustic communications can be utilized as disclosed by Zhou et al. in U.S. Pat. No. 7,859,944, for example. The components of the secondary vehicles and the payload 151 will be discussed in more detail below.

### Signal Processing

As illustrated in FIG. 4A, each secondary vehicle 150 processes the received signal RS from the primary vehicle 110 in an innovative process. Each receiver 153 from the receiver mechanism 152 receives signal S and transfer the recorded signals RS to the controller 156, which in turn performs the raw measurement processing 402, including match filtering 404 to estimate range 158 between primary and secondary systems. Simultaneously, the recorded signal measurements RS from each receiver is processed by the controller with beamforming 406 (i.e. spatial filtering) such that the recorded signals RS experience constructive interference when estimated to be at or near the azimuth and inclination combination 160 (referred herein as look-angles) that represents the vector to the actual transmitter. An initial estimation of azimuth and inclination is achieved using a modified phased-array beamforming. However, phased-array beamforrning is computationally intensive, and the present invention utilizes a novel approach, referred herein as Sequential Monte-Carlo (SMC) Beamforming, to enable real-time location determination relative to a fixed or moving priMary vehicle.

### Sequential Monte-Carlo Beamforming

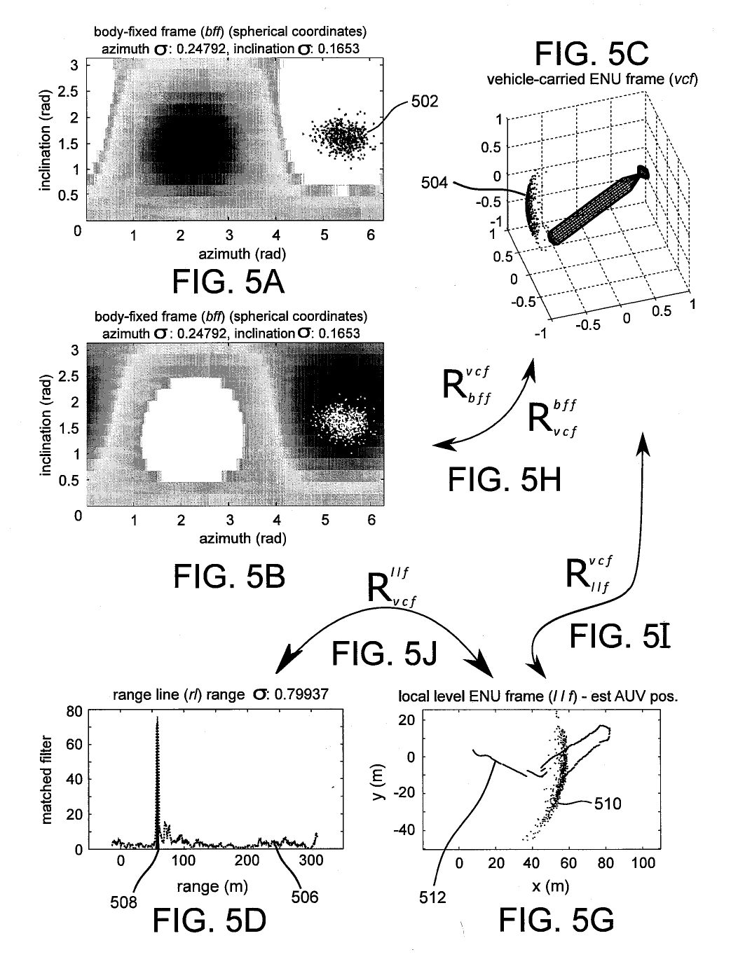

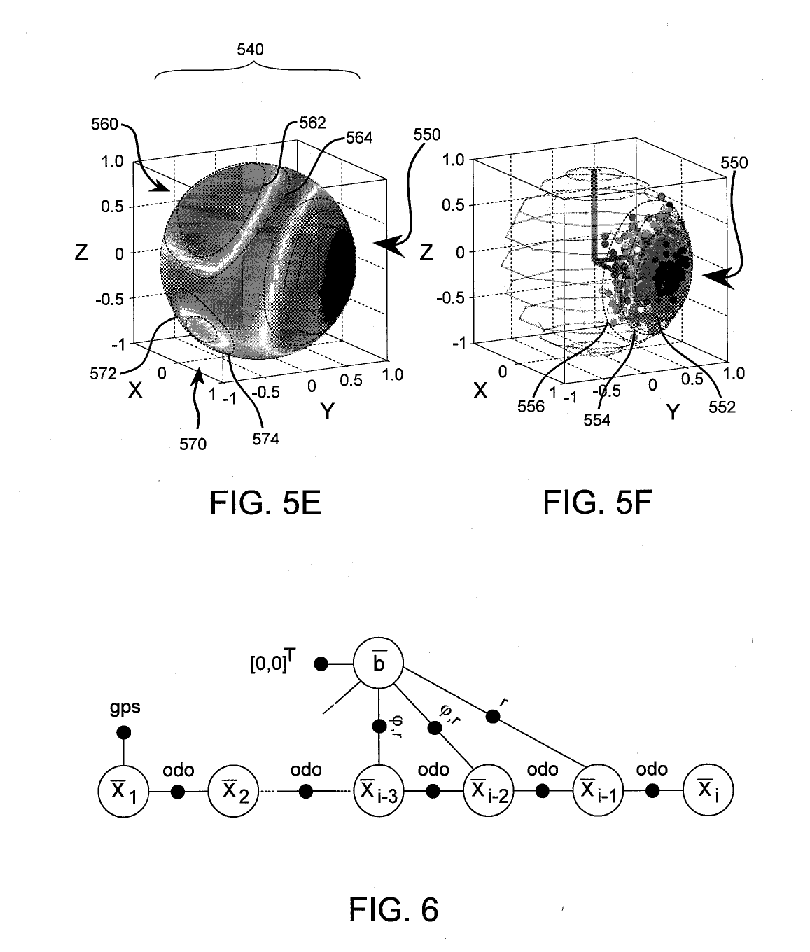

Phased-array beamforming, described in more detail below, involves iterating over a large set of look-angles in a three-dimensional space, depicted in FIG. 5E as a set covering 360 degree sphere 540. The look-angles are investigated to determine which look-angle has a maximum output power (i.e. constructive interference between received signals RS). Performing an exhaustive search over all possible look-angles, as illustrated in FIG. 5E, is computationally expensive. In one embodiment, an exhaustive search uses a gridded search-space of 4050 look-angles at about 1.25 Hz, providing an angular resolution of 1.33 degrees in azimuth and 12.00 degrees in inclination. A larger set of look-angles provides a finer angular resolution, but at the expense of additional computational power, or increased computational time. In one embodiment, a set of look-angles 540 representing a 360 degree exhaustive search is completed over time to establish relative location of a secondary 150 to the primary 110.

In the currently preferred embodiment, the secondary 150 utilizes SMC beamforming 400 to select a sub-set of look-angles to determine secondary relative location. SMC beamforming is an approach that closely couples 440 raw signal processing 402 (including matched filtering 404 and beamforming 406), with particle filtering 420 in real-time. This close coupling is referred herein as the beamformer plus particle filter 440 (B+PF) approach. SMC beamforming 400 results in an algorithm whose computational complexity scales with the number of particles rather than set size, while allowing for the seamless integration of motion model odometry 422 with instantaneous received signal measurements RS.

As illustrated in FIGS. 4A, 5E and 5F, the SMC beamforming approach allows for the search space to be constrained to the most likely set of look-angle candidates, computed using vehicle motion model 422. Particle weights are updated and resampled 424 as the secondary moves from the beamforming output 407, and a grid of look-angles 410 (and enlarged in FIG. 5F), with values indicating the likeliest direction to the primary is produced 499. These particles (set of look-angles) with the likeliest direction to the primary, represent a significantly smaller particle set 410 than a set representing an exhaustive search, and the beamformer 406 is only performed directly at these subset of particles 410. In this computational domain, the state of each particle is an azimuth-inclination combination, and thus each particle represents a specific look-angle. Therefore, SMC beamforming allows for the controller to beamform only at the look-angles represented by the set of particles in the filter, directly updating the particles weights in a single step. Therefore, instead of performing only real-time beamforming with 4050 gridded look-angles, the present invention performs combined beamforming and particle filtering in real-time with a much smaller set of particles. In effect, the present invention makes use of a certain complementarity between beamforming and particle filtering—the particles in the filter constrain the search space of beamforming to the area most likely to contain the maximum value (using the filter's motion model), and the beamformer provides the measurement update to each particle's weight.

A particle filter is uniquely suited for angular estimation with beamforming for the following reasons: firstly, the response of an array is generally multimodal in nature (e.g. domains 550, 560 and 570), and this multimodality is often made worse by signal effects such as multipath and environmental noise; secondly, spherical coordinates mean that the particles remain within a small, closed domain; and thirdly, the particles themselves represent the look-angles at which beamformer spatial filtering is performed, greatly reducing computational complexity while improving estimation accuracy.

Reference Fames and Transformations. The innovative SMC Beamformer uses three reference frames, each frame using a right-hand coordinate system. The Forward-Port-Above body-fixed frame (bff), in which beamforming is performed, see Eqs. 19-24; the vehicle-carried East-North-Up frame (vcf), whose origin is fixed to the secondary's center of gravity; and the vehicle-carried East-North-Up local-level frame (llf), whose origin is also fixed to the secondary's center of gravity, but in which both range and angle to the primary 110 are combined to estimate relative primary position, and in which the filter motion update step is applied. A set of N particles with associated weights Wᵢ^{llf} are stored in the llf and used to model the relative position of the primary, with their states given by Equation 1.

\vec{s}ᵢ^{llf}(t)=[xᵢ^{llf}(t)yᵢ^{llf}(t)zᵢ^{llf}(t)]^{T} Eq. 1

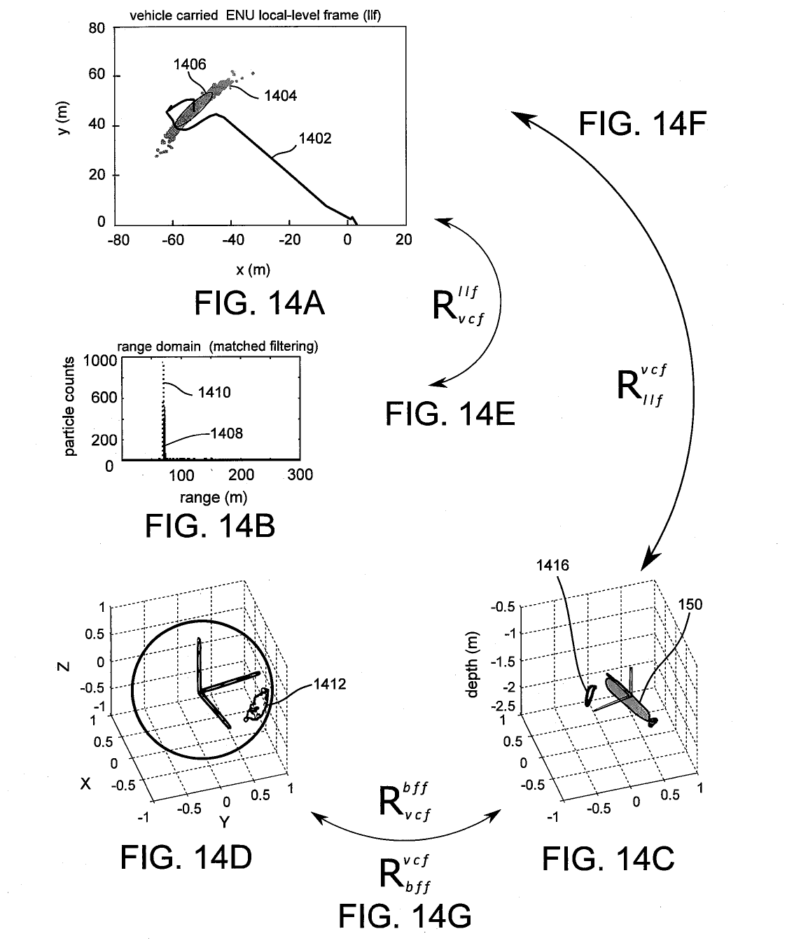

Transforming between this set of combined range-angle llf particles, \vec{s}ᵢ^{llf} (t), and the separated range and angle particles in the range domain and the vcf requires the beamformer to perform a duplication of the set through a transformation denoted by R_{llf}^{vcf}, FIG. 14F. This is achieved by vector normalization and magnitude calculation respectively to get an angle-only vcf particle set \vec{s}^{vcf} (t) and a range-only particle set r(t), as demonstrated in Equation 2, where rᵢ(t) and \vec{s}^{vcf} (t) are demonstrated in Equations 3 and 4, respectively.

$$\begin{matrix}( {\vec{s}}_{i}^{vcf} ( t ) , {r}_{i} ( t ) ) = {R}_{llf}^{vcf} ( {\vec{s}}_{i}^{llf} ( t ) ) & Eq . 2 \\ {r}_{i} ( t ) = ‖ {\vec{s}}_{i}^{llf} ( t ) ‖ & Eq . 3 \\ {\vec{s}}_{i}^{vcf} ( t ) = {[ {x}_{i}^{vlf} ( t ) {y}_{i}^{vlf} ( t ) {z}_{i}^{vlf} ( t ) ]}^{T} = \frac{{\vec{s}}_{i}^{llf} ( t )}{‖ {\vec{s}}_{i}^{llf} ( t ) ‖} & Eq . 4\end{matrix}$$

The corresponding weights of these two sets are denoted as wᵢ^{bff} and wᵢ^{r}. And they are set equal to wᵢ^{llf} during the transform of Equation 5.

(wᵢ^{bff}, wᵢ^{r})=wᵢ^{llf} Eq. 5

The range-only particles rᵢ are now properly in the range domain for fusion with range measurements. However, the angle-only vcf particles \vec{s}^{vcf} must still be transformed into the domain in which beamforming occurs, which is the bff. Here, it becomes clear why the weights of the angle-only particles are denoted by wᵢ^{bff}—the vcf is only used as an intermediary frame between the llf and the bff. Transforming from the vcf to the bff is denoted by R_{vcf}^{bff}, FIG. 14G, as shown in Equations 6 and 7 and FIGS. 14A-14D and 14G, which is a rotational transformation using secondary vehicle roll (γ)-pitch (β)-yaw (α) with the standard rotational matrices. The angle-only particles are not in the correct domain for beamforming. Transposing this rotational matrix provides the inverse transformation, denoted by Eq. 8.

\vec{s}ᵢ^{bff}(t)=[xᵢ^{bff}(t)yᵢ^{bff}(t)zᵢ^{bff}(t)]^{T}=R_{vcf}^{bff}·\vec{s}^{vcf}(t) Eq. 6

R_{vcf}^{bff}=R_{z}(α)R_{y}(β)Rₓ(γ) Eq. 7

R_{bff}^{vcf}=(R_{vcf}^{bff})^{T} Eq. 8

The inverse transformation from the separate range-only and angle-only particle sets back into the combined range-angle set \vec{s}ᵢ^{llf} (t) has a caveat: rather than multiplying each angle-only particle \vec{s}^{vcf} (t) and their associated weights wᵢ^{bff} by every range-only particle rᵢ and weight wᵢ^{r} (which would result in N² particles in \vec{s}ᵢ^{llf}(t), the present invention instead sorts \vec{s}^{vcf} (t) and r(t) in ascending order according to their respective weights wᵢ^{bff and w}ᵢ^{r}; the inverse transform R_{vcf}^{llf}, FIG. 14E, is then the element-wise multiplication of the sorted range-only and angle-only particle sets and their weights, shown in Equations 8 and 9.

$$\begin{matrix}{\vec{s}}_{i}^{bff} ( t ) = {R}_{vcf}^{llf} ( {\vec{s}}_{i}^{vcf} ( t ) , {r}_{i} ( t ) ) = {\vec{s}}_{i}^{vcf} ( t ) \cdot {r}_{i} ( t ) & Eq . 8 \\ {w}_{i}^{llf} = \frac{{w}_{i}^{bff} \cdot {w}_{i}^{r}}{\sum ( {w}_{i}^{bff} \cdot {w}_{i}^{r} )} & Eq . 9\end{matrix}$$

Weighted angle particles in the body-fixed frame 1412 are shown in FIG. 14D.

These equations allow for the estimation to maintain a constant number of N particles efficiently during duplication and recombination and performs well in practice. The reference frames used by the sequential SMC beamformer and the transformations between each are shown in FIGS. 14A-14G. A histogram is shown in FIG. 14B illustrating range-domain with matched filter output 1408 and range particle counts 1410. Vehicle-carried ENU frame with vehicle attitude and angle particles 1416 are shown in FIG. 14C relative to secondary vehicle 150. Combined range-angle weighted particles in the vehicle-carried ENU local-level frame 1404 are shown in FIG. 14A, with an area of high-density particles 1406 in the center. FIG. 14A also shows the secondary trajectory 1402.

Initialization. In order to improve computation time, the SMC beamformer first precomputes and stores in memory the spatial filter 408 H[ω; θ, ϕ] containing phase-shifts associated with a regular grid of look-angles, with the grid parameters selected as a trade-off between memory consumption and angular resolution. This grid is later used as a look-up-table for phase-shifts nearest to a given look-angle.

Initialization of the filter is dependent on whether or not the primary vehicle is fixed or mobile. In both cases, all weights of the llf particles, \vec{s}ᵢ^{llf} (t), initialized with equal weights, wᵢ^{llf}=1/N, when the secondary vehicle is on the liquid body surface SS, in the vehicle-carried East-North-Up (ENU) frame whose origin is fixed and centered around the secondary vehicle. In addition, the particles are reinitialized whenever the secondary vehicle surfaces.

If the primary is fixed at a known position, the llf particles are initialized around the primary's relative position using knowledge of the secondary's GPS position and noise. If the primary is mobile, the llf particles are instead initialized randomly with a uniform distribution within a spherical volume centered around the secondary and extending to the system's maximum range. One embodiment's range is calculated in Equation 10. The filter makes the strong assumption that the primary 110 is within the system's range when the secondary is deployed.

$${r}_{max} = \frac{1481 m \text{/} s}{37500 samples \text{/} s} \cdot 8000 samples \approx 316 m \qquad Eq . 10$$

The second step of the SMC beamforming is performed upon secondary movement, referred herein as motion update 422. Once the secondary vehicle dives and loses GPS reception, the particles are updated with a simple motion model that uses estimates of the secondary's speed-over-ground (Vg) and yaw (α), provided to the payload 151 by the secondary vehicle 150 (e.g. a SandShark AUV). Because the present invention does not require a DVL, most embodiments will lack such a system, speed-over-ground can be calculated using the secondary's propulsion mechanism (e.g. propeller speed, or RPM) that is scaled by some calibrated factor C and compensated by pitch (β), as demonstrated in Eq. 11. Because the filter is estimating the relative position of the primary in the secondary vehicle-centered llf, the direction opposite to secondary vehicle's direction of travel is used to propagate the llf particles \vec{s}ᵢ^{bff} (t) as shown in Equation 12, where Δz is the secondary vehicle's change in depth from its pressure sensor, and Gaussian noise has been added to vehicle speed and yaw. The final term, N(0, σᵥ_{_{bcn}}²) is noise added to the particles that is representative of the speed of the primary. If the primary is fixed, its value is zero.

$$\begin{matrix} {V}_{g} = C \cdot RPM \cdot cos ( β ) & Eq . 11 \\ {\vec{s}}_{i}^{llf} ( t ) = {\vec{s}}_{i}^{llf} ( t ) ( t - Δ t ) - ( {V}_{g} + N ( 0 , {σ}_{{v}_{g}}^{2} ) ) \cdot [ \begin{matrix}Δ t cos ( α + N ( 0 , {σ}_{α}^{2} ) ) \\ Δ t sin ( α + N ( 0 , {σ}_{α}^{2} ) ) \\ 0\end{matrix} ] - [ \begin{matrix}0 \\ 0 \\ Δ z\end{matrix} ] + N ( 0 , {σ}_{{v}_{bcn}}^{2} ) & Eq . 12\end{matrix}$$

Measurement Updates. Whenever the secondary system 151 receives a valid signal measurement RS, the \vec{s}ᵢ^{llf} (t) local-level frame particle set is first transformed into duplicate sets of particles in the range-domain and body-fixed frame, using equations 2, 3, 4, 5, 6 and 7. This transformation gives a range-only particle set, r(t), and an angle-only particle set, \vec{s}ᵢ^{bff} (t), along with their associated weights wᵢ^{r} and wᵢ^{bff}.

The weights wᵢ^{r} of the particles r, in the range domain are updated by multiplying against the range signal outputted from the matched filtering Equations 15 and 16. Systematic resampling is then used to resample and reweight this set of range-only particles.

The particles \vec{s}ᵢ^{bff} in the bff now represent look-angles at which to perform beamforming. The standard Cartesian-to-spherical transform provides the azimuths (ϕ) and inclinations (θ) at which to apply the set of beamforming equations, shown in Equations 19-24. Upon completion of beamforming at these look-angles, the weights wᵢ^{bff} of these angle-only particles are updated by multiplying against their corresponding beamformer output power, and systematic resampling is performed to obtain an updated particle set. The transform R_{vcf}^{llf} then places these particles into the vehicle-carried frame.

All that remains to be done is to transform these updated range-only and angle-only particle sets back into the local-level frame, which is done using the recombination Equations 8 and 9. The filter loop then repeats.

Likelihood Estimation. To estimate the relative position of the primary, the weighted mean of the particles \vec{s}ᵢ^{llf} in the local-level frame is used. When the primary is fixed at a known position, absolute localization (e.g. latitude and longitude coordinates) is possible by negating the relative primary position and offsetting the result by the absolute coordinates of the primary. For a moving primary, the relative position enables the secondary to operate in a primary-relative coordinate frame.

The localization performance of the SMC beamformer is comparable to the two-stage conventional B+PF approach described elsewhere herein. The SMC beamformer computational gain can be naively estimated as follows: assuming that the conventional beamformer processing time of a single look-angle is n milliseconds (ms), and the filter loop time of a single particle is m ms, given N look-angles and M particles, the total processing time for the two-stage B+PF approach is approximated in Equation 13. Conversely, for the SMC beamformer, the processing time is approximated in Equation 14.

((N·n)+(M·m)) Eq. 13

M·(n+m)=((M·n)+(M·m)) Eq. 14

Given the desired angular resolution of the beamformer, it is often the case that M<<N, and therefore the net reduction in processing time is about ((N−M)·n) ms. Filter performance in terms of both accuracy and computational efficiency is now directly proportional to the single parameter of the number of particles M.

The SMC beamformer allows for fine tuning of the system according to the computational power of a specific embodiment. Firstly, by increasing the resolution of the grid of look-angles, the look-up-table consumes more memory, but improves precision by more accurately representing the true beamformer power output for a given particle. Secondly, accuracy is imporved by increasing the number of particles, but at the cost of greater computation time. In one example of the present invention, a regular grid of 22 inclination and 360 azimuth angles, resulting in 519 Mb of memory usage, or about half the memory available on a Raspberry Pi 3 controller is used. 1500 particles are used to achieve sub-second rates, fast enough for real-time performance.

### Matched Filtering

The secondary vehicle estimates range to the primary through the use of matched filtering 404, as illustrated in FIGS. 4E and 4F. The time-domain signals on each receiver 153a-153d are essentially cross-correlated with a template of the broadcast signal, and the absolute value of the result is taken. If the standard deviation of the arg-maximums from all resulting signals (e.g. all four hydrophones of the embodiment in FIGS. 3, 4E-4F) is below a specifable threshold, then the receiver's signal measurement is deemed valid (invalid measurements typically occur when the vehicle obstructs the receiver). The plurality of received signals are then combined by taking the sum of the product of all unique signal combinations. Finally, this combined output is normalized and converted from the time-domain to range-domain by multiplying by the speed of sound in the liquid body LB (e.g. approximately 1481 m/s in freshwater), resulting in a range signal that provides an instantaneous estimate of distance between the secondary and the primary.

In one construction, matched filtering is performed with measurements from each of the four hydrophones to obtain a range estimate signal 506. This is in essence a convolution between hydrophone i's received signal, xᵢ[n], and a replica of the signal (e.g. an up-chirp) h[n], shown in Equation 15.

yᵢ[n]=Σₖ₌₀^{N-1}h[n−k]xᵢ[k] Eq. 15

The output yi[n] reaches a maximum at the sample number at which xi[n] most closely resembles the broadcast signal template replica h[n] . The standard deviation of this sample number across the four elements can be used as a measure of the validity of the array measurement, shown in Equation 16.

$$σ = \sqrt{\frac{1}{3} {\sum }_{i = 1}^{4} ( {argmax}_{n} ( {y}_{i} [ n ] ) - \frac{1}{4} {\sum }_{i = 1}^{4} {argmax}_{n} ( {y}_{i} [ n ] ) )} \qquad Eq . 16$$

When σ<5 we deem the measurement valid. Invalid measurements occur when the signal S is not received by all receivers 153, which occurs primarily due to self-occlusion—the body of the secondary obstructs the transmitted signal S. The matched filter output from all receivers are combined and smoothed using moving average, shown in Equations 17 and 18 to generate the range estimate:

$$\begin{matrix}{y}^{′} [ n ] = {\sum }_{i , j = 1}^{4} \vert {y}_{i} [ n ] \vert \vert {y}_{j} [ n ] \vert i \neq j & Eq . 17 \\ y [ n ] = \frac{1}{N + 1} {\sum }_{i = \frac{N}{2}}^{\frac{N}{2}} {y}^{′} [ n + 1 ] N even & Eq . 18\end{matrix}$$

Finally, sample numbers n are converted to ranges by subtracting the characterized systemic delay and scaling by the ratio of approximate sound velocity in the liquid body, here for freshwater over sampling rate (r=(c/Fₛ), n=1480/37500·n). This range estimate signal y[n] is normalized and passed on to the particle filter. FIGS. 4B-4D illustrates typical outputs of our matched filtering process.

### Phased-Array Beamforming

Phased-array beamforming is also performed using the raw measurements, giving an azimuth-inclination heatmap estimating the angle-of-arrival relative to a frame of reference for the secondary vehicle such as the body-fixed frame of a secondary. Assuming a planar incident sound wave and isotropic receiver response, beamforming is done by iterating through various azimuth-inclination combinations (look-angles), using the array geometry to apply time delays (phase shifts) to the received signals RS, and summing these time-delayed signals. The look-angle with the maximum response is the likeliest angle-of-arrival of the incident wave, which occurs when the signals are in phase and add constructively.

In other words, the aim is to steer the beamformer over a set of candidate look-angles, and to select the look-angle that results in the maximum beamformer output power; this occurs when the look-angle points in the direction of the incoming plane wave and the phase-shifted signals add constructively, as shown in FIGS. 4E and 4F.

The time delay τᵢ of a plane wave arriving from a specific look-angle at each element can be calculated as shown in Equation 19, where \vec{u} is shown in Equation 20.

$$\begin{matrix}{τ}_{i} = - \frac{{\vec{u}}^{T} {\vec{p}}_{i}}{c} & Eq . 19 \\ \vec{u} = [ \begin{matrix}sin ( θ ) cos ( φ ) \\ sin ( θ ) sin ( φ ) \\ cos ( θ )\end{matrix} ] & Eq . 20\end{matrix}$$

where \vec{p}ᵢ is the position of receiver 153 (e.g. a hydrophone), and ϕ and θ are the look-angle azimuth and inclination, and c is the speed of sound in the liquid body. This time delay is constant for a given look-angle, but corresponds to phase shifts in the frequency domain that increase with frequency, as shown in Equation 21. Applying the time delay from Equation 20 to the signal fᵢ received by receiver i (e.g. a hydrophone), is equivalent to applying phase-shifts in the frequency domain (Eq. 21).

$${f}_{i} [ n - {τ}_{i} ] {⇌}^{DFT / IDFT} {F}_{i} [ ω ] \cdot {e}^{- j \vec{ω} {τ}_{i}} \qquad Eq . 21$$

where fᵢ is the plane wave signal incident on receiver i, and \vec{ω} is the vector of frequencies output by the n-point DFT. Beamforming negates these geometrically-induced time delays by using the spatial filter 408 H [ω; θ, ϕ] for each element that applies opposing phase-shifts and sums over all elements in Equations 22 and 23. The Beamformer frequency-averaged output power is then calculated by Equation 24.

$$\begin{matrix}Y [ ω ; θ ; ϕ ] = {\sum }_{i = 1}^{4} {H}_{i} [ ω ; θ ; ϕ ] \cdot {F}_{i} [ ω ] & Eq . 22 \\ {H}_{i} [ ω ; θ ; ϕ ] = {c}^{j ω {τ}_{i}} & Eq . 23 \\ {\vert \tilde{Y} \vert θ , ϕ \vert \vert}^{2} = \frac{1}{n} {\sum }_{n} {\vert Y \vert {ω}_{n} ; θ ; ϕ \vert \vert}^{2} & Eq 24\end{matrix}$$

The previously described matched filter 404 is applied to the received signals RS to enhance detection, and the Chirp Z-transform is used rather than a full DFT to reduce n without loss of resolution in the frequency range of interest. When a look-angle is pointing toward the primary, the output power is large. By steering (i.e. iterating) the look-angle over a set of candidates and searching for the largest response, the likeliest angle to the primary 110 can be found, providing an instantaneous estimate of the azimuth and inclination between the secondary and primary, as summarized in Equation 25. Steering look-angles involves iterating through a set of candidate look-angles, analyzing the response (output) level of each, and comparing the current response to the maximum output found in the set so far.

$$( \tilde{θ} , \tilde{ϕ} ) = \begin{matrix}arg max \\ ϕ , θ\end{matrix} {\vert \tilde{Y} \vert ϕ , θ \vert \vert}^{2} \qquad Eq . 25$$

Unlike previous methods, which utilize a two-stage offline (e.g. non-real-time and not onboard the secondary vehicle) process of conventional beamformer processing followed by the sampling of the beamform output by a particle filter, to fuse signal measurements and odometry, the present invention discloses a method of closely coupling beamforming with particle filtering (the SMC beamformer). This tight integration is key in enabling closed-loop, online secondary navigation. Online navigation is performed in real-time on the secondary vehicle itself, and not on another, remote platform/computer.

In some embodiments, alternative beamforming algorithms are performed, as now described. The likely angle-of-arrival (i.e. look-angle) can be found by iterating through a set of look-angles, to find the maximal output, which would mean the look-angle is equal to the true angle-of-arrival of the incident wave. The iteration of a number of look-angles, produces an azimuth-inclination heatmap, g[ϕ,θ], as describe in Equations 26 and 27.

$$\begin{matrix}g [ φ , θ ] = {max}_{n} ( g [ n ; {τ}_{i} ( φ , θ ) ] ) g [ φ , θ ] = {max}_{n} ( g [ n ; {τ}_{i} ( φ , θ ) ] ) & Eq . 26 \\ ( {φ}^{*} , {θ}^{*} ) = {argmax}_{φ , θ} ( g [ φ , θ ] ) ( {φ}^{*} , {θ}^{*} ) = {argmax}_{φ , θ} ( g [ φ , θ ] ) & Eq . 27\end{matrix}$$

This heatmap is passed on to the particle filter when 265°≤ϕ*≤95° and 45°≤θ*≤135° to prevent error caused by self-occlusion. FIGS. 5A-5B illustrate a typical heatmap. Real-time on-board beamforming is achieved despite its computational complexity by using two techniques: firstly, the phase shifts associated with each look-angle are precomputed and stored; secondly, instead of the full DFT we use the Chirp Z-transform to limit frequency domain operations to a range of interest (6-10 kHz)—this reduces the number of frequency domain points without loss of resolution.

### Particle Filter Localization

Matched filtering and beamforming provide instantaneous and noisy estimates of range and angle-of-arrival respectively. In addition, underwater acoustic propagation frequently exhibits undesirable properties such as multi-path and reflections, resulting in outliers and measurement distributions that are non-Gaussian. Consider the three valid matched filtering outputs in FIGS. 4B-D; in this embodiment, the true range between the primary and secondary is approximately 75 m; however, the measurement depicted in FIG. 4C has a false maximum FM at 265 m. This suggests that simply using argmax on range and angle-of-arrival measurements could result in significant error in localization. The non-Gaussian nature of these measurements, and the desire to fuse measurements with secondary attitude information and motion model, motivate the use of a particle filter for localization rather than a regular EKF.

The particle filter of the present invention makes use of three main coordinate frames: the Forward-Port-Above body-fixed frame (bff), in which acoustic angle-of-arrival measurements are made (Eqs. 5-9); the vehicle-carried East-North-Up frame (vcf), whose origin is fixed to the center of gravity of the AUV; and the local-level East-North-Up frame (llf), whose origin we define to be the primary position and within which the secondary vehicle navigates. At time instant t, the filter models the azimuth-inclination to the beacon using a set of N particles and associated weights wᵢ^{x} which reside on the unit ball in the vehicle-carried frame. A second set of N particles and weights wᵢ^{r} residing on a 0-300 m range-line (rl) are maintained to estimate range to the beacon using matched filtering measurements (Eqs. 15, 17, 18). Two particle sets are used due to the independent nature of range and azimuth-inclination measurements. The state vectors of the particles in each set are given by Equation 28:

\vec{s}ᵢ^{x}(t)=[xᵢ^{vcf}(t), yᵢ^{vcf}(t), zᵢ^{vcf}(t)]^{T} and

\vec{s}ᵢ^{r}(t)=[rᵢ^{rl}(t)]\vec{s}ᵢ^{r}(t)=[rᵢ^{rl}(t)] Eq. 28

Typically, the particle filter is initialized using the secondary's positioning module (e.g. GPS measurements) when the secondary is on the liquid body surface SS awaiting deployment. Secondary GPS position is transformed into the local-level frame by subtracting primary location, and particles are initialized in this frame centered around the positioning module position. These particles are then transformed to the secondary vehicle-carried frame 504 and range-line 508 for state vector storage as give in Equations 29 through 32.

$$\begin{matrix}{n}_{i} \sim N ( 0 , {σ}_{GPS}^{2} ) & Eq . 29 \\ {w}_{i}^{x} ( 0 ) = {w}_{i}^{r} ( 0 ) = 1 / N & Eq . 30 \\ {r}_{i}^{r 1} ( 0 ) = \sqrt{{( {x}_{GPS} ( 0 ) + {n}_{i} )}^{2} + {( {y}_{GPS} ( 0 ) + {n}_{i} )}^{2} + {( {n}_{i} )}^{2}} & Eq . 31 \\ [ \begin{matrix}{x}_{i}^{vcf} ( 0 ) \\ {y}_{i}^{vcf} ( 0 ) \\ {z}_{i}^{vcf} ( 0 )\end{matrix} ] = [ \begin{matrix}( - {x}_{GPS} ( 0 ) + {n}_{i} ) {r}_{i}^{r 1} ( 0 ) \\ ( - {y}_{GPS} ( 0 ) + {n}_{i} ) {r}_{i}^{r 1} ( 0 ) \\ {n}_{i} / {r}_{i}^{r 1} ( 0 )\end{matrix} ] & Eq . 32\end{matrix}$$

where (xGPS, yGPS) is the local-level frame GPS position and σGPS is the standard deviation of GPS measurement noise (or other positional module locational information). The transform from the local-level to the vehicle-carried frame 504 and range-line 508 is denoted by R_{llf}^{vcf}, FIG. 5I. This transform is performed by negating and normalizing the local-level particles to get vehicle-carried particles 504 (Eq. 32), and calculating particle magnitudes to get range-line particles (Eq. 31). Particles are re-initialized whenever a locational fix is received.

1) Prediction: In the prediction step the two particle sets are sorted in ascending order according to their weights. The particles are then transformed to the local-level frame by combining both sets (essentially by element-wise multiplication)—a transform denoted by R_{vcf}^{llf} (Eq. 34 and FIG. 5J). Vehicle pitch (θ^{vcf}) and yaw (φ^{vcf}) as well as speed estimated from prop RPM (v) are then used to propagate the combined particles using our motion model, defined in Equations 33-35. Finally, the particles are transformed and separated back into the vehicle-carried frame and range-line, and Guassian noise added to each particle, as defined in Equation 36.

$$\begin{matrix}let {\vec{T}}_{i}^{x} ( t ) = {[ {x}_{i}^{llf} ( t ) , {y}_{i}^{llf} ( t ) , {z}_{i}^{llf} ( t ) ]}^{T} & Eq . 33 \\ {\vec{T}}_{i}^{x} ( t - Δ t ) = - {\vec{S}}_{i}^{x} ( t - Δ t ) \cdot {\vec{S}}_{i}^{r} ( t - Δ t ) & Eq . 34 \\ {\vec{T}}_{i}^{x} ( t ) = {\vec{T}}_{i}^{x} ( t - Δ t ) + [ \begin{matrix}Δ tv sin ( {θ}^{vcf} ) cos ( {φ}^{vcf} ) \\ Δ tv sin ( {θ}^{vcf} ) sin ( {φ}^{vcf} ) \\ Δ tv cos ( {θ}^{vcf} )\end{matrix} ] & Eq . 35 \\ ( {\vec{S}}_{i}^{r} ( t ) , {\vec{S}}_{i}^{x} ( t ) ) = {R}_{llf}^{vcf} ( {\vec{T}}_{i}^{x} ( t ) ) + \vec{n} \sim N ( θ , {σ}_{r , x}^{2} ) & Eq . 36\end{matrix}$$

Storing the particles in the vehicle-carried rather than the body-fixed frame allows us to exclude attitude propagation in the update step. This reduces computation, since attitude updates occur much faster than acoustic measurements.

2) Update: Whenever a valid azimuth-inclination heatmap or range estimate signal 506 is received, weights are updated and the particles resampled. For the range particle set, the update step is: particle weights are multiplied by the value of the range estimate signal corresponding to their associated ranges, and resampling and weight normalization is done using systematic resampling. For the azimuth-inclination particle set are first transform the particles into the body-fixed frame using vehicle pitch (θ^{vcf}), roll (Ψ^{vcf}) and yaw (φ^{vcf})—a transformation denoted as R_{vcf}^{bff}, FIG. 5H, and described in Equation 37 and 38, where RΦ is the standard Cartesian to spherical transform, and Rz, Ry, and Rx are the standard rotation matrices.

let \vec{U}ᵢ^{Φ}(t)=[ϕᵢ^{bff}(t), θᵢ^{bff}(t)]^{T} Eq. 38

\vec{U}ᵢ^{Φ}(t)=R_{Φ}((R_{z}(ϕ^{vcf})R_{y}(θ^{vcf})Rₓ(ψ^{vcf}))^{T}\vec{S}ᵢ^{x}(t)) Eq. 39

In the body-fixed frame the azimuth-inclination particles are represented using spherical coordinates 502; their weights are multiplied with the corresponding azimuth-inclination heatmap values, and resampling and weight normalization is performed using systematic resampling. Finally the particles are transformed back into the vehicle-carried frame using the inverse rotation matrices and the standard spherical to Cartesian transform—this process is denoted as R_{bff}^{vcf}, FIG. 5H.

3) Estimation: Estimation is performed by calculating the weighted means of both the range and azimuth-elevation particle sets in the body-fixed frame. Transformation of the range and azimuth-elevation means into the local-level frame 510 provides an estimate of the secondary position (and trajectory 512 in this construction) in the local- level frame. In addition, the means transformed into vehicle-carried frame are used during factor graph smoothing. The particle filter output is set to a definable particle number. In one embodiment, the output of the particle filter is set to 500 particles, along with visualizations of the particles in each coordinate frame can be seen in FIGS. 5A-5J, which also illustrates typical outputs of the matched filtering and beamforming processes.

Factor Graph Smoothing: Although the particle filter provides an estimate of the secondary vehicle's location, it does so by recursively marginalizing out all previous measurements, resulting in a trajectory that often contains discontinuities. A factor graph smoothing algorithm can improve this by utilizing all particle filter measurements to optimize over the full secondary trajectory 512. This approach results in a smoother and more consistent trajectory, while still retaining the robustness against acoustic outliers provided by the particle filter.

\vec{x}ₜ=[xᵢ, yᵢ, ϕᵢ]^{T} Eq. 40

In this approach, the estimate the secondary vehicle's pose, as shown in Equation 40, in the local-level frame using a factor graph smoothing framework to represent the collection of poses over the entire trajectory. Each node \vec{x}ᵢ in the graph corresponds to the pose estimate at time i, and is linked to preceding and subsequent pose nodes by odometry constraints calculated using our motion model, as depicted in FIG. 6. The factor graph of FIG. 6 shows \vec{x}ᵢ being secondary vehicle poses connected by motion model odometry (“odo”) and b is the primary pose (beacon pose) connected to secondary vehicle poses by either azimuth-range (φ, r) or range-only (r) measurements. The initial secondary vehicle pose has a prior factor from GPS measurements (“gps”), and the primary has a prior factor of [0, 0]^{T}, placing it at the origin. When a valid signal measurement appears, the pose node is linked to a primary node as shown in Equation 41, by either an azimuth-range or range-only constraint outputted by the particle filter. In addition, the initial pose is constrained by a prior, which represents surface positional module measurements in the local-level frame. The primary node is also constrained by a prior, [0, 0]^{T}, as it represents the origin of the local-level frame. The GTSAM library (Dellaert 2012, Technical Report number GT-RIM-CP&R-2012-002, incorporated herein by reference) was used, and specifically the iSAM2 algorithm to incrementally perform maximum a-posteriori inference over the factor graph as it is constructed. Motion and measurement noise are independent and assumed to be Gaussian, with the standard deviation of measurement noise estimated directly using the particles from the filter.

\vec{b}=[x_{b}, y_{b}]^{T} Eq. 41

### Primary Vehicle Details

The primary vehicle 110 comprises a positioning mechanism 112, a transmitter 116, and a controller 113. The positioning module 112 obtains positional information relating to the location of the primary vehicle. The positional module may comprise any suitable positioning system known in the art, for example a GPS receiver. Most often the output of the positioning module is absolute positional information, represented by latitude and longitude coordinates. In one embodiment, the positioning module comprises a DVL-INS system to determine its underwater position and to generate positional information. The generated positional information is transferred to the controller for the proper generation of a signal S.

The controller 156 comprises a digital controlling device, performing all common informational receiving, relaying and transmitting commands between electrical components in the payload 151, and in the secondary vehicle 150. Often the controller comprises a single board controller, for example a Raspberry Pi computer. In other embodiments, the controller 156 comprises an interconnected Arduino Uno microcontroller with a Wave Shield for audio transmission. In some embodiments, the controller comprises more than physical structure, separated by control over different components, for example the controller 156 may further comprise a DAQ and amplifier 170 and a battery and power board 172.

The positioning module 112 comprises any suitable device that can precisely determine the position of the primary vehicle. In some embodiments, the positioning module 112 comprises a GPS receiver unit. In other embodiments, the positioning module 112 comprises a

DVL-aided INS or DVL-aided IMU (inertial measurement unit). The positioning module 112 in the currently preferred embodiment comprises a Garmin 18xLvC GPS unit, from which the rising edge of the pulse-per-second (PPS) signal is used to trigger playback of a pre-recorded 20 msec, 7-9 kHz linear up-chirp signal output by the Wave Shield.

The primary vehicle's signal generation and timing unit 114 in turn transfers locational information in the precisely time-synced pulse to the secondary vehicle. In some embodiments, the timing aspect of the signal generation and timing unit originates from the localization mechanism in the form of the GPS PPS signal. In other embodiments the unit comprises a precise timing device, as described in more detail for the secondary vehicle, below. In one construction, the PPS signal from this GPS receiver is input into a digital pin on the Arduino Uno equipped with an Adafruit Wave Shield, which allows it to precisely detect the onset of each second; this in turn triggers the Wave Shield to output a user-defined acoustic signal stored on a SD card.

In some embodiments, the primary transmitter 116 further comprises an acoustic modem, as described by Zhou et al. in U.S. Pat. No. 7,859,944. Such embodiments allow for at least the one-way transfer of information from the primary 110 to one or more secondary vehicles 150. In such embodiments, the signal S is still produced as described above to provide secondary vehicles 150 with properly timed locational information, however additional information can be encoded into the acoustic signal and relayed passively to the secondary vehicle(s), or sent in a separate signal. In some embodiments, the acoustic modem is used to send the same information to all secondary vehicles present. In other embodiments, the acoustic modem uses time slots to encode information for specific secondary vehicles. The duration and number of dedicated time slots are limited such that the inventive system's precise synchronization and localization are not impacted, when incorporated into the positioning signal S. In further embodiments the secondary vehicle 150 further comprises an acoustic modem enabling two-way communications between primary and secondary.

### Transmission Mechanism

The transmission mechanism 116 comprises any suitable transmitting system suitable for submersion and the production of precisely timed signals. In the currently preferred embodiment, the transmission mechanism 116 comprises a Lubell UW30 amplifier and a LL916C underwater speaker. In other embodiments, the transmission mechanism 116 comprises an optical transmitter, a radio-frequency transmitter or a combination of suitable modalities. Fan et al. in U.S. Patent Publication No. 2016/0127042 describe in more detail examples of combinatorial transmitters suitable for a transmission mechanism in the present invention.

### Secondary Vehicle Details

The present invention provides for at least one submersible object, referred as a secondary, to receive signals S from the primary to establish positional information while submerged. The secondary comprises a payload 151. The payload 151 comprises at least a receiving mechanism 152, and a controller 156. The receiver 152, most often comprises a plurality of individual receivers 153, most preferably at least two receivers, each receiver configured to receive signals S sent by the primary. In the currently preferred embodiment, the receiver mechanism comprises a hydrophone array with at least two hydrophones, at least three hydrophones or preferably, at least four hydrophones, spaced in a tetrahedral array. In some embodiments, the receiver mechanism is mounted on the nose of the payload (FIG. 3), in other embodiments, the receiver mechanism is mounted on top of the payload. The individual hydrophones in the array are preferably spaced to receive the signal with significantly different times. The receivers 153 are spaced less than 2 cm apart, 2 cm apart, 4.5 cm apart, 7.5 cm apart, 10 cm apart or more than 10 cm apart. In one construction, the array utilizes four HTI-96-Min hydrophones with current-mode pre-amplifiers, which are used to detect the broadcast acoustic signal. The received signal passes through a custom analog board that performs current-to-voltage conversion and minimal amplification, and then to the interconnected controller 156.

The secondary payload 151 also comprises a timimg funtion. In some embodiments, the timing funtion, including time-keeping and time-syncronization (to the primary) are incorporated into the controller 156. In other embodiments, the timing functions are controlled by a separate digital device, referred as a timing unit 154. In one embodiment, the timing unit is a Measurement Computing USB-1608FS-Plus digital acquisition 162 (DAQ) device is provided to perform timing functions in conjuction with a SA.45 chip-scale atomic clock 164 (CSAC) as well as analog-to-digital conversion from the CSAC as well as other payload analog devices. In the currently preferred embodiment, the DAQ 162 is triggered to record 8000 samples every second at a sampling rate of 37.5 kS/s. And this digital signal is processed using the controller 156 (e.g. a a Raspberry Pi 3 embedded computer) using an online navigation algorithm as described in more detail elsewhere herein. In other embodiments, the timing unit comprises a Jackson Labs GPS disciplined oscillator containing a SA.45 CSAC, providing the payload 151 with a highly precise GPS-synchronized PPS signal. The CSAC is synchronized to the GPS PPS signal before deployment, and maintains time-synchronization while the secondary vehicle is submerged.

The CSAC triggers the DAQ at the onset of each second, allowing the receiver mechanism 152 to record signal measurements RS in sync with primary broadcasts, effectively enabling OWTT ranging to the primary (e.g. an acoustic beacon). The timing unit provides a time base that typically drifts by less than 0.5 ms/day, but it makes up a disproportionate amount of the cost of the receiving system.

In other embodimetns, alternative time syncing methods or mechanisms can be used. A carefully selected microcontroller-compensated crystal oscillator may provide a less expensive time base that drifts by only ms/day or lower. In embodiments, where the secondary vehicle 150 is tethered, GPS PPS can be directly relayed from the surface to achieve a significant reduction in cost. In other embodiments, the primary vehicle's motor or other sound-producing system produces a reproducible acoustic waveguide invariant, and that invariant is used to determine range. Harms et al (2015 IEEE International Conference on Acoustics, Speech and Signal Processing (ICASSP), p. 4001-4004), incorpoarted by reference in full, describes a method for ranging an acoustic source (i.e. a primary) based on analyzing fading characteristics of different acoustic tonal components of the waveguide invariant parameter beta. In some embodiments of the present invention, the Harms' method is modified by using a standarized acoustic source on the primary vehicle to determine secondary positional information. The secondary vehicle 150 times the recipt of the different tonal components emitted from the primary vehicle 110 and calculates range based on the seperation of the tonal components, as described above.

The secondary vehicle 150 often further comprises common components made available to the payload 151 through a typical digital interface 168 include, MEMS IMU with magnetometer, depth pressure sensors, GPS units, propellers, and control fins. Navigation data, including vehicle attitude and speed, is pre-filtered by the vehicle 150 from IMU and prop RPM information. The controller 156 uses this filtered data to command vehicle 150 depth, heading, and speed. The payload 151 most often also comprises a power source 166, comprising any suitable battery or electrical generator as known in the art.

### EXAMPLE 1

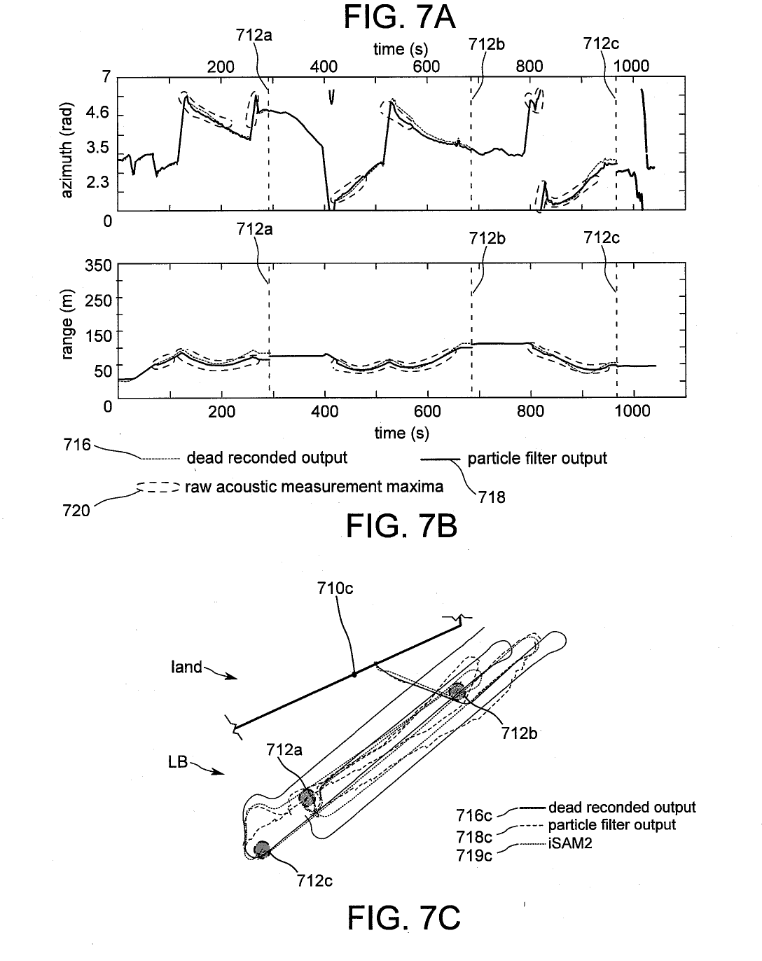

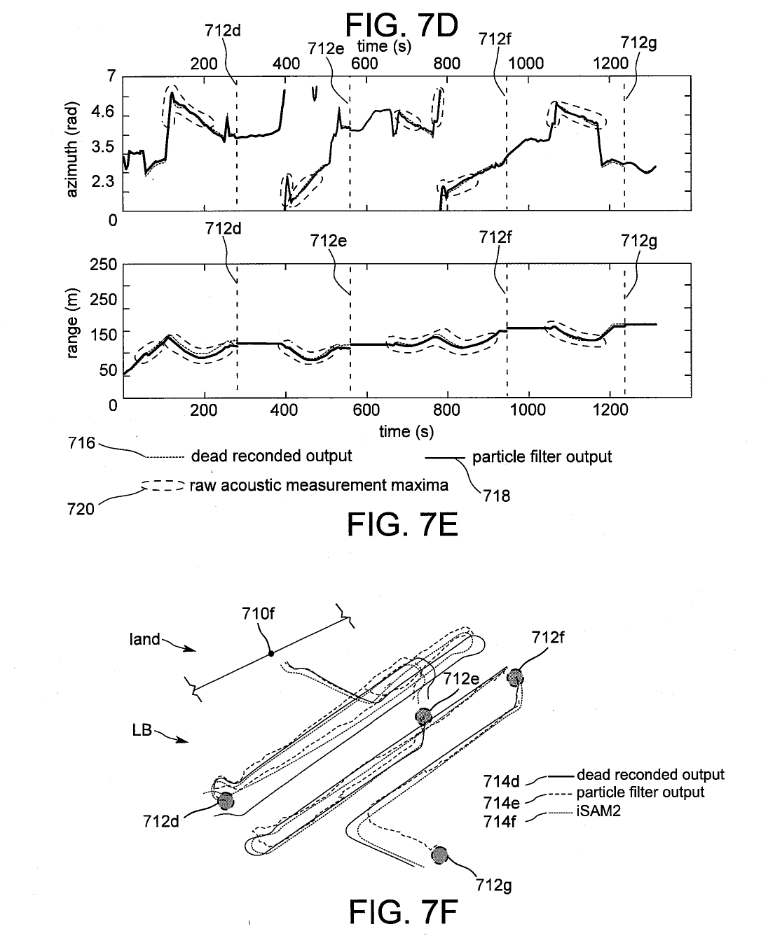

Referring to FIGS. 7A-7F, experiments were performed using our SandShark AUV with acoustic payload (i.e. the secondary payload 151) on a portion of the Charles River by the MIT Sailing Pavilion. Our acoustic beacon (i.e. the primary 110) was submerged to about 0.5 m depth and fastened to the pavilion dock, at a known GPS position 710c and 710f. The AUV was pre-programmed with a mission where it was instructed to travel back-and-forth along the dock for 170 m at 2 m depth and a speed of 1.4 m/s. The mission duration was set to 1200 s, and the AUV was instructed to surface for a 120 s GPS fix 712a-712g whenever it was at the end of a 170 m run and the time since the last fix was greater than 150 s.

Both matched filtering and phased-array beamforming were performed on the Raspberry Pi 3 in real-time at approximately 1.25 Hz with 4050 look-angles (15 inclination and 270 azimuth equally-spaced angles). This data was recorded by the payload along with pre-filtered navigation data from the vehicle, which was received by the payload at a rate of about 10 Hz. The payload and AUV system clocks were synchronized using an NTP server running on the payload.

Particle filtering and factor graph smoothing were performed offline. 500 particles were used for both the azimuth-inclination and range set. iSAM2 was used to build and solve the factor graph with vehicle poses added at a rate of 5 Hz and using ranges and azimuths output by the particle filter. A new graph was initialized each time the AUV received a GPS fix, allowing us to monitor the difference in estimated and true position during the underwater to surface transition.

The AUV was deployed for two runs (designated run 1 and run 2), with the vehicle surfacing for three GPS fixes during the first and four GPS fixes during the second. For the two runs we perform a qualitative comparison between the trajectories 714 resulting from vehicle dead reckoning, particle filtering, and factor graph smoothing. We also use a simple metric to assess the inter-GPS-fix navigation performance of the three methods over both runs: during the underwater to surface transition a discontinuity in position occurs when the AUV gets a GPS fix, which is caused by localization error during underwater navigation; smaller jumps would indicate better performance. Unfortunately, this metric is subject to GPS positional error.

Plots of azimuth, FIGS. 7A and 7D, and range, FIGS. 7B and 7E, from the AUV to the beacon, as estimated from dead reckoning 716 (dotted line) and our particle filter 718 (solid line), along with argmax measurements from matched filtering and beamforming as dashed circles 720. We see that the particle filter successfully fuses the observed acoustic measurements with the dead reckoned motion model, pulling the estimate towards observations. Our validity checks are apparent when looking at the measurements—no azimuth measurements exist between 95 degrees (1.66 rad) and 265 degrees (4.62 rad), which are invalid due to self-occlusion. Even though outliers exist in the range measurements, these are filtered out by the particle filter.

The plots of FIGS. 7C and 7F display the resulting trajectories for the three methods for both runs, with dead reckoning 716 (solid line), particle filtering 718 (dashed line), and iSAM2 factor graph smoothing 719 (dotted line). The three GPS fixes 712a-712c for the first run occur at (−26, −61) (294 s), (−50, −88) (686 s), and (45, −10) (967 s). For the second run, the four fixes 712d-712f occur at (−27, −65) (280 s), (62, −28)(559 s), (104, −11) (945 s), and (63, −88) (1236 s). The positional jumps that occur during these fixes are listed in Table 1 below, along with the average jump distance and standard deviation for the three methods:

TABLE 1

| | | | | | | | | | Std. |
|---|---|---|---|---|---|---|---|---|---|
| | Run 1 GPS Jumps | | | Run 2 GPS Jumps | | | | Mean | Dev. |
| Dead | 8.6 | 4.8 | 33.0 | 8.3 | 8.0 | 6.4 | 12.7 | 11.7 | 9.7 |
| Reckoning | | | | | | | | | |
| Particle | 2.4 | 11.8 | 9.4 | 6.0 | 8.9 | 6.1 | 4.3 | 7.0 | 3.2 |
| Filter | | | | | | | | | |
| Factor | 2.9 | 5.4 | 5.3 | 10.4 | 5.8 | 6.4 | 8.6 | 6.4 | 2.4 |
| Graph | | | | | | | | | |

Qualitative examination of the trajectories indicate that the dead reckoned estimates are the least self-consistent, with large discontinuities when the secondary vehicle surfaces for a fix. The particle filter trajectories are better in this respect, but they suffer from non-continuity caused by incorporation of latest observations in the filter's recursive estimate. The trajectories resulting from iSAM2 on the other hand are both the most self-consistent, and maintain a smooth, continuous trajectory between GPS fixes; this is a result of optimizing over the entire vehicle history, incorporating all acoustic measurements. These observations are supported by the jump distances in Table 1 above, showing that the iSAM2 approach has both the smallest average discontinuity, and the lowest standard deviation.

Besides the inherent positional uncertainty associated with GPS measurements, possible sources for the observed differences between GPS and our localization approach include motion due to river currents, which cannot be accounted for; inaccurate characterization of the systemic delay in the source/receiver system; inaccurate measurement of the acoustic array element positions; as well as jitter in the onset of the acoustic beacon signal—a maximal 2 ms delay in the onset of the beacon transmission at a sound speed of 1480 m/s corresponds to a 2.96 m error, which is on the same order of magnitude as the differences observed.

### EXAMPLE 2

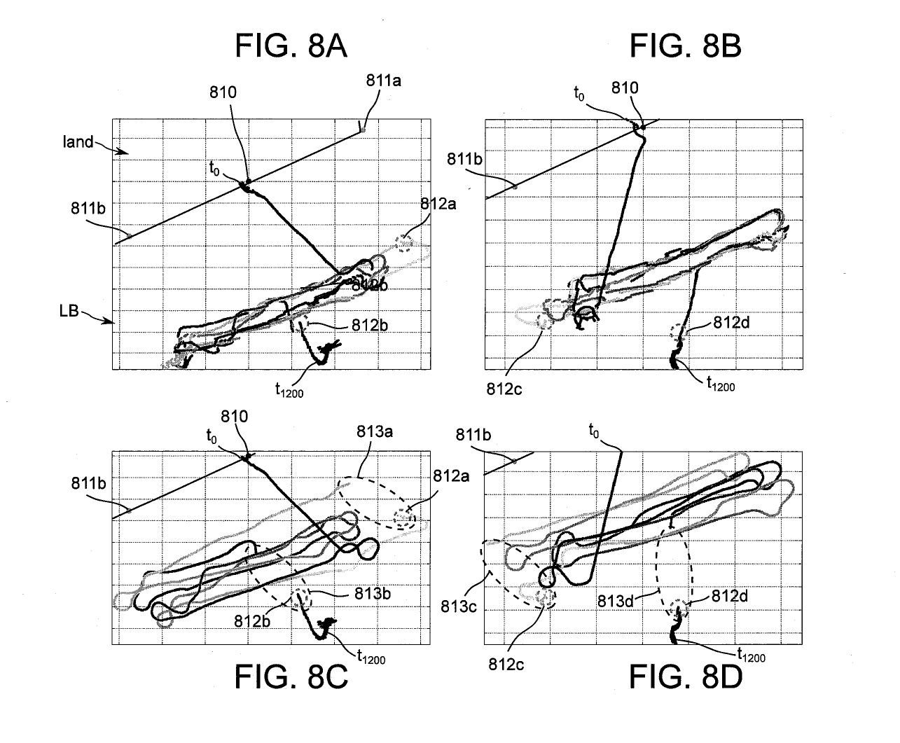

To demonstrate single-beacon piUSBL absolute navigation, we carried out two additional closed-loop deployments (designated run 3 and run 4) of our SandShark AUV on a portion of the Charles River adjacent to the MIT sailing pavilion, illustrated in FIGS. 8A-8D. Our custom acoustic beacon (i.e. primary 810) was set to broadcast a 20 ms, 16-18 kHz linear frequency modulated (LFM) up-chirp, and was affixed to the pavilion dock and submerged to a depth of approximately 1 m. The SandShark (i.e. a secondary vehicle 150 plus payload 151) was programmed to run a mission to follow a racetrack parallel to the dock of 90 m length and 10 m width, at a depth of 2 m and a speed of 1 m/s. The mission length was set to 1200 s, with the vehicle instructed to surface for GPS approximately mid-way through the mission.

Since GPS is unavailable underwater, we also deployed two commercial Hydroid LBL transponders 811a, 811b fastened to the pavilion at a depth of approximately 1 m, with the first transponder at position (52:8; 23:8) m and the second at (−55:6; −25:6) m relative to our custom acoustic beacon.

The SandShark payload is equipped with a WHOI micromodem that is not used for any purpose other than to query the LBL transponders at a rate of 0.2 Hz. This allows us to compare our solutions to the range values outputted by this independent system, providing a means for quantifying navigation accuracy. Note that the LBL system itself is subject to acoustic effects that result in range outliers. In order to remove these outliers, a simple constant velocity filter is employed—essentially, if the difference between subsequent LBL ranges is above the distance that can be achieved by the vehicle moving at maximum speed in that time delta, then that LBL measurement is discarded. This ensures that physically impossible LBL ranges are pruned from each dataset, but even so, some outliers still remain.

Results. FIGS. 8A-8D displays the trajectories for run 3 (FIGS. 8A and 8B) and run 4 (FIGS. 8B and 8D), estimated by our piUSBL system (FIGS. 8A8B) as well as naive deadreckoning (DR), FIGS. 8C-8D. The piUSBL estimates were used by the AUV for closed-loop navigation to follow the desired racetrack. Qualitative examination of these plots indicate that the piUSBL approach allows the vehicle to successfully self-localize, as evidenced by the minimal jumps in estimated position whenever the AUV surfaces and GPS reception is restored 812a-812d. In contrast, DR experiences jumps 813a, 813b (dashed ellipses) in position during run 3 of almost 30 m and 28 m during the mid-mission and end-mission surfacing events respectively; similarly, DR for run 4 has jumps 813c, 813d of about 33 m and 36 m for these two surfacing events. A back-and-forth racetrack mission like this is expected to minimize dead-reckoning error, and demonstrates how quickly this error accumulates (at a rate of almost 3 m/min) in the absence of a DVL-aided INS and in the presence of water currents. AUV trajectories are plotted in grayscale to indicate elapsed mission time, with to indicating t=0s (beginning of mission) and t₁₂₀₀ indicating t≈1200 s.

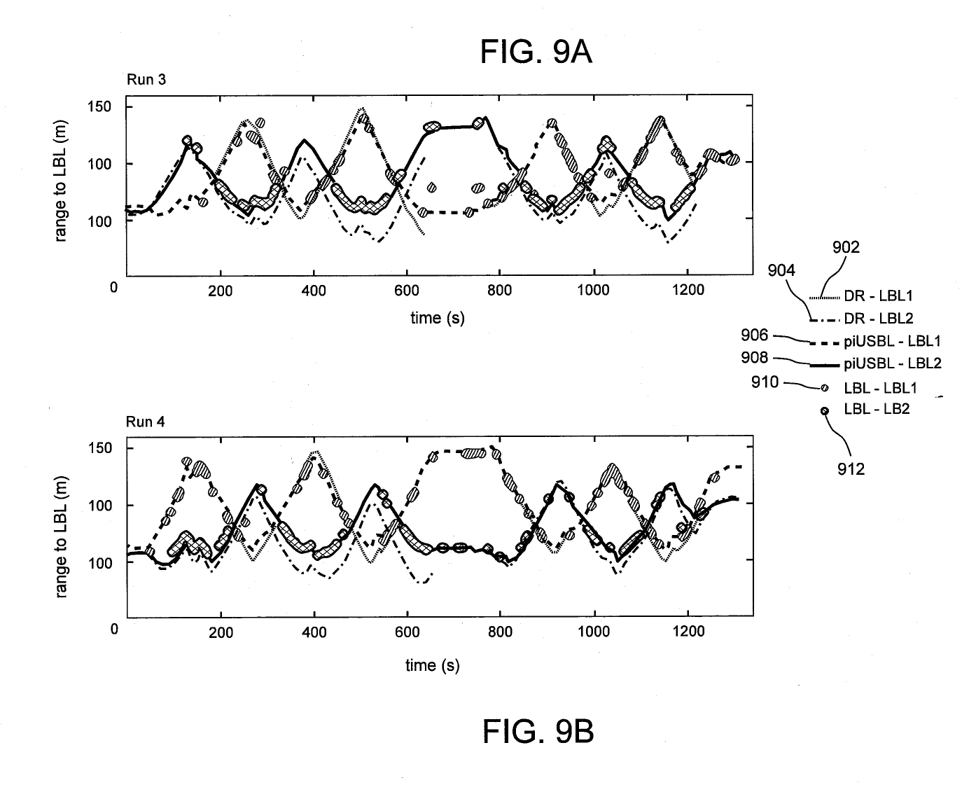

Ranges from these trajectories to the two commercial LBL transponders are plotted in FIG. 9A-9B. These plots support our previous observations, illustrating close agreement between the ranges output by the independent LBL acoustic system and the trajectory resulting from our piUSBL approach. Range estimates are depicted as range between DR and LBL1 902 (dotted line), DR and LBL2 904 (dash-dot line), piUSBL and LBL1 906 (dashed line), piUSBL and LBL2 908 (solid line), LBL raw values and LBL1 910 (thin bordered, cross-hatched areas), and LBL raw values and LBL2 912 (thick bordered, hatched areas). Two runs are depicted; run 3 in FIG. 9A and run 4 in FIG. 9B. Again, naive DR quickly diverges from the transponder ranges.

Although the LBL system is queried by the vehicle at a rate of 0:2 Hz, only about 32% of those queries were met with a valid response (detected with power above a certain threshold), indicating the acoustically challenging nature of the river (LB). As a result, an even smaller percentage (˜10%) of LBL ranges occur concurrently for both beacons—without concurrent ranges, LBL-based localization is not possible; this is the reason why we have opted to compare piUSBL to LBL range measurements directly, rather than compare piUSBL and LBL position estimates. Outliers in the LBL ranges are apparent (e.g. in run 3 650-760 s when the vehicle is stationary while receiving GPS), but this data still allows us to validate the navigational ability of our system.

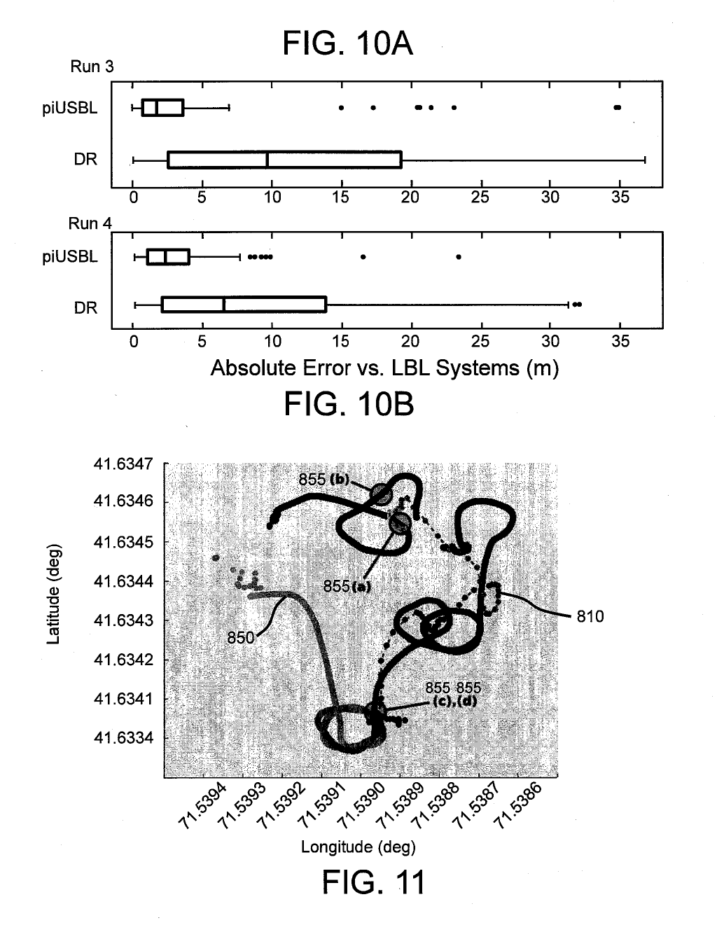

Taking the absolute difference between the ranges outputted by the trajectory estimates and the raw ranges from the LBL system allows us to plot error statistics with respect to LBL, as shown in FIGS. 10A-10B. For run 3, piUSBL has a median error of 1:74 m, with 75% of measurements falling below 3:62 m; and for run 4, piUSBL has a median error of 2:22 m, with 75% of measurements falling below 3:90 m. The mean absolute error (MAE) for piUSBL is 3:14 m and 2:91 m for runs 3 and 4 respectively, while for DR it is 11:14 m for run 3 and 9:42 m for run 4. These results suggest that the piUSBL system significantly improves the navigational ability of the SandShark AUV.

MOVING BEACON RELATIVE NAVIGATION. Field Experiments. To validate the feasibility of the relative navigation operating paradigm, we performed an initial test using our SandShark AUV (i.e. the secondary) in Ashumet pond in Falmouth, Mass. In this run, our custom acoustic beacon (i.e. the primary) was manually towed by an inflatable kayak, and was set to broadcast a 20 ms, 7-9 kHz LFM up-chirp (FIGS. 2D-2E), at a depth of about 1.5 m. Custom MOOS-IvP behaviors instructed the vehicle to dive to 1.5 m and search for the beacon, home-in on it, and continuously loiter in a 12 m diameter circle around it, as the beacon was periodically repositioned. The kayak operator was instructed to station-keep for a few minutes at different positions in the operating area until the end of the mission after 650 s of time had elapsed. In essence, the primary position is treated as the moving origin of a relative navigation frame within which the AUV operates, and the vehicle is tasked with a loitering mission around the origin of this frame.

Unfortunately, in this case no LBL system was deployed, and so only the internal odometry of the AUV was available to estimate absolute AUV position. To verify that the vehicle was indeed homing in on the beacon, a forward-pointing GoPro camera was mounted to the payload, allowing us to visually confirm the beacon during flybys.

Results. FIG. 11 displays the dead-reckoning trajectory of the vehicle 850 (secondary), as well as the GPS positions of the kayak/beacon 810 (primary). The vehicle trajectory 850 is displayed as a thick solid line, line darkness increasing with mission duration. The primary trajectory 850 is displayed as a dashed line with circle symbols, circles lightness representing elapsing mission time. Circles 855(a)-855(d) indicate underwater visual confirmation of the primary during flybys by the secondary (with the incorporated GoPro camera). The kayak/beacon moved through three different station-keeping latitude/longitude coordinates—the first at about (41:6346;-70:5388), the second at approximately (41:6343;-70:5387), and the third at about (41:6341;-70:5388). Although DR is fairly inaccurate, the trajectory of the vehicle is indicative of successful detection, tracking, homing, and loitering by the AUV around the beacon, while being repositioned, with three distinct loitering patterns visible. The inaccuracy of the absolute DR estimate is apparent when looking at the jump in position from a GPS update during an unexpected surfacing event at (41:6345;-70:5387), as well as when the vehicle surfaced at the end of the mission.

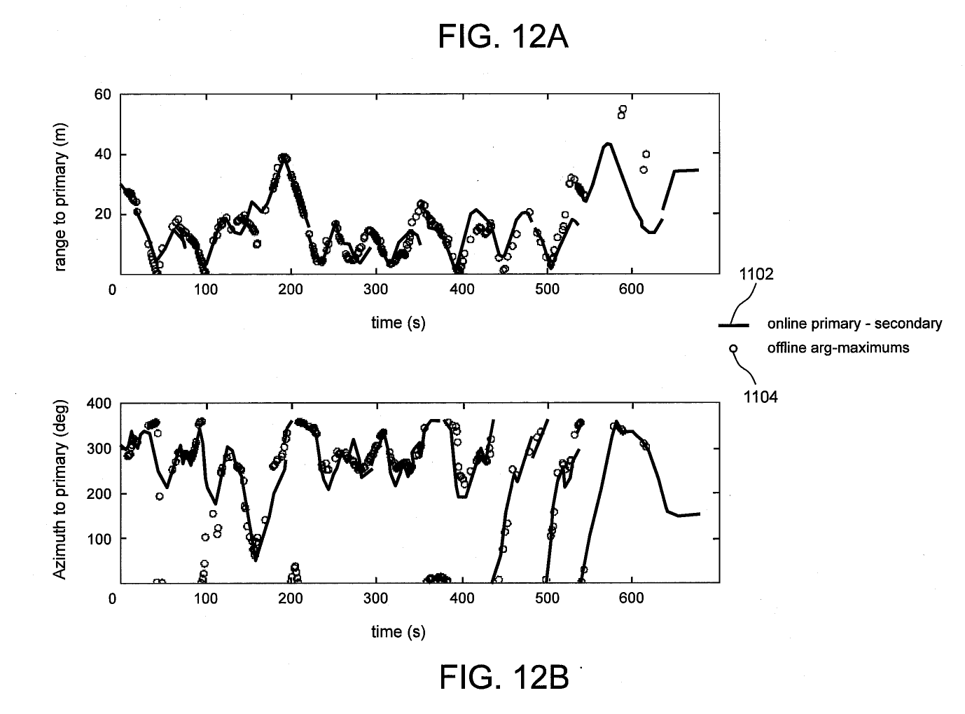

FIGS. 12A-12B illustrates plots of the estimated range (FIG. 12A) and azimuth (FIG. 12B) calculated from our beacon state estimate \vec{s}^{llf} (t) of our real-time piUSBL system 1102, overlaid with argmaxs 1104 of the range signal and beamformer power output, calculated offline through exhaustive search. Outliers in the range and beamformer measurements are apparent, but are well rejected by the piUSBL filter. The good agreement between the argmax measurements and the filtered signal indicates that our sequential Monte-Carlo beamformer approach works well to integrate the measurements with the AUV motion model, even with a mobile beacon (primary). Discontinuities in the piUSBL output are likely due to long periods of acoustic occlusion, during which the filter is unable to incorporate measurement updates.

Alternative Systems: This invention has been presented above as a system to localize a small, low-cost AUV using a single primary source, either fixed or mobile. One construction utilizes uses OWTT of known signal emitted by the source to estimate range, and an AUV mounted array to estimate angle to the primary source using matched filtering and beamforming. These measurements are fused with an AUV motion model using a particle filter, then smoothed with a factor graph-based algorithm to provide a good-performance AUV localization estimate, without the use of conventional sensors such as a DVL or high-grade INS. It is acoustically passive on the AUV, reducing power use and cost, and enabling multiple AUVs to localize using a single beacon.

Alternatives according to the present invention include deploying two primary source beacons with different chirp signals to remove vehicle dependence on magnetometer for yaw, which limits vehicle deployment to areas devoid of large magnetic anomalies; and implementing online versions of particle filtering and factor graph smoothing to perform closed loop navigation with our factor graph estimate.

As described above, one or more secondary vehicles such as an AUV uses pitch-roll-heading combined with matched filtering and beamforming to calculate range, azimuth, and inclination to a single fixed beacon, thereby resolving an instantaneous estimate of its position. In some constructions, systems and methods according to the present invention enables real-time, on-board, consistent estimation of primary position by closely coupling phased-array beamforming and particle filtering. In addition to improved localization and computational performance, such an extended system enables a novel operating paradigm for AUVs—navigation relative to a non-stationary beacon whose absolute position is opaque to the vehicle. Since a major limitation of USBL approaches is the decrease in positional accuracy with increasing range due to angular error, this paradigm enables the AUV to bound its positional error by continuously operating in close proximity to a mobile beacon, facilitating AUV deployments over large spatial length scales.

As described above, systems according to the present invention an approach that enables a miniature, very low-cost autonomous underwater vehicle (AUV) to self-localize and navigate without the use of large, expensive, and power-hungry conventional AUV navigational sensors, such as a Doppler velocity log (DVL) or a high-grade attitude and heading reference system (AHRS). Our system has two defining characteristics: it uses a single primary beacon to periodically broadcast a known signal into a liquid body, which greatly improves usability and reduces system cost; and it uses a vehicle-mounted USBL array to passively detect and process the broadcast signal to generate an estimate of primary beacon position, easily permitting the system to scale to a large number of vehicles. Our approach uses matched filtering to estimate one-way travel-time range to the primary beacon, and a beamformer spatial filter to estimate azimuth and inclination between the vehicle and the primary beacon. Closed-loop AUV navigation using an inexpensive embedded computer is achieved through the close coupling of beamforming and sequential Monte-Carlo beamforming and filtering, allowing the vehicle to fuse signal measurements with motion-model odometery in a computationally efficient manner, resulting in the online generation of consistent and accurate estimates of relative beacon position. We have experimentally shown the ability of our system to accurately perform closed-loop, absolute navigation in the case where the beacon is fixed at a known position, verifying our results against an independent commercial LBL positioning system. In addition, preliminary results of the vehicle navigating relative to a moving beacon have demonstrated the feasibility of this operating paradigm, opening up the future possibility of multi-AUV deployments over large spatial length scales.

The low-cost, low-power nature of this system makes it ideally suited to a variety of applications. Besides enabling multiple miniature, low-cost AUVs to self-localize, this approach can be used on conventional, high-cost AUVs or gliders to enable long-duration deployments, or under-ice navigation; it is ideal as a navigational aid for vehicles in the emerging consumer remotely-operated vehicle (ROV) space, since its cost can be further reduced by time-synchronization over the tether; and it can enable novel AUV operating schemes, such as coordinated surveys with multiple vehicles, or multi-AUV formations for environmental acoustic monitoring.

In yet another system according to the present invention, a second primary acoustic beacon is utilized, which may improve localization accuracy at a modest downgrade in ease-of-use. The use of two primary beacons will also enable the estimation of heading without a magnetometer, which is especially useful for low-cost AUVs and ROVs that experience magnetic interference in structured environments.

### EXAMPLE 3

### Relative Autonomy for Command and Control

The objective of this example is a secondary vehicle command and control methodology that is easy to maintain as secondary vehicle formations scale up in number, while providing accurate acoustic navigation for a new generation of miniature, lowcost AUVs that lack high-fidelity navigational sensors (i.e. a DVL-aided INS). This method was demonstrated in field trials in which three SandShark AUVs were placed in the water, and were commanded to different patterns based on the broadcast acoustic waveform and position of a single beacon (i.e. primary) in the Charles River.

The implications for this operational paradigm are to make multi-vehicle operations easier on the operator. Each AUV has a unique identifier assigned automatically on launch, and which determines parameterized offsets in x (Δx), y (Δy), depth (Δz), range (r) and heading (θ) retrieved from a pre-defined look-up table. Desired vehicle state in each operational mode is then determined by the estimated relative position of the primary, the autonomous secondary vehicle behavior assigned to the mode, and the set of retrieved offset parameters. Since depth is also configurable with offsets, vehicles may be stacked in depth using these behaviors.

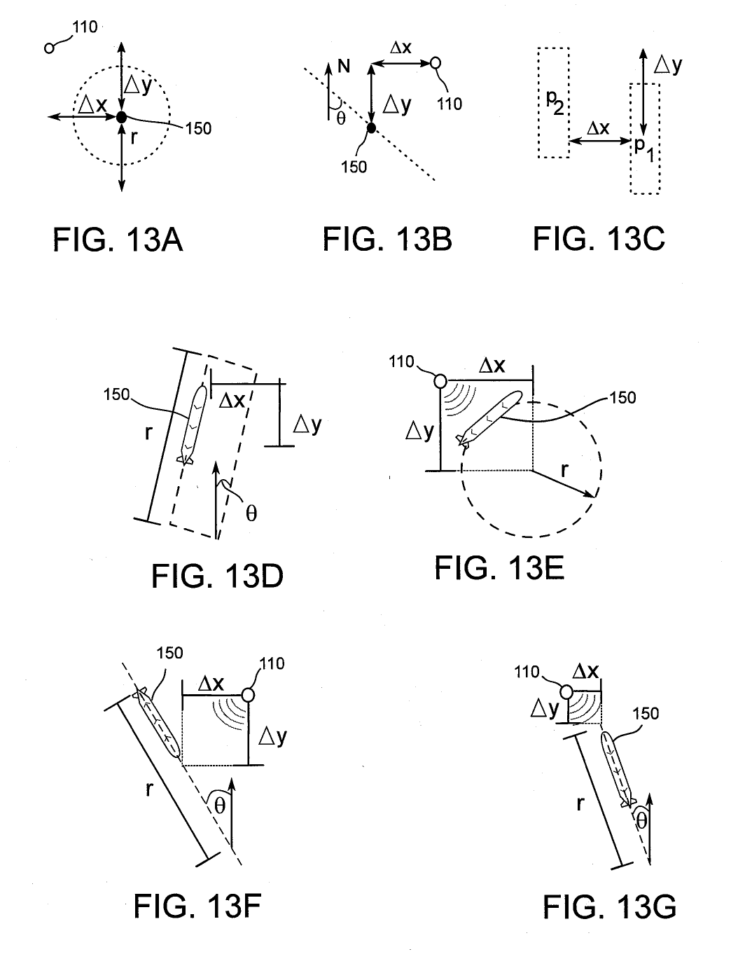

This methodology can be extended for use with a transmitter carried by an intelligent primary vehicle, such as a conventional AUV outfitted with high-fidelity navigational sensors or an autonomous surface vehicle (ASV), resulting in a deployment paradigm that enables the operational command and control of AUV groups autonomously or remotely. The autonomous behaviors commanded by the dial in these experiments were ‘Default’, ‘Relative Loiter’, ‘Relative Line’, ‘Return and Surface’, and ‘Abort’. An illustration of how these behaviors are configured using the parameterized offsets in the x-y plane is shown in FIGS. 13A-G. As illustrated in FIG. 13D, ‘Default’ is a pre-determined AUV behavior in a local, absolute (non-moving) frame of reference—it is used at the start of the deployment when the transmitter is not transmitting in order to launch multiple AUVs in preparation for the operator (in a motorboat carrying the transmitter) to get into the field for relative operations; during this time, the AUVs navigate without acoustics by dead-reckoning using propeller speed and IMU heading, resulting in a navigational accuracy that degrades rapidly. For the presented experiments a racetrack behavior was used, automatically shifted based on the per vehicle parameterized offsets. All other behaviors are defined in coordinates relative to the beacon and navigate using the beacon as an acoustic aid.

As illustrated in FIG. 13E, the ‘Relative Loiter’ behavior associated with mode 1, the vehicle sets a counter-clockwise circular loitering pattern with radius r at a distance of Δx, Δy from the estimated primary position 150. For the ‘Relative Line’ as illustrated in FIG. 13F, behavior associated with mode 2, the desired track is set to move the AUV 150 along a line that is of length r and at a heading of θ, with a distance from the primary 110 to the center of this line of Δx and Δy. Of the other two behaviors associated with modes 3 and 4 (not illustrated). Illustrated in FIG. 13G, ‘Return and Surface’ has all vehicles 150 return along a track of length r and heading θ, and surface at a configurable fix, Δy offset from the primary 110. Another mode, ‘Abort’ has all vehicles 150 stop and surface at their current position. For all relative behaviors, the desired track moves with the primary 110, so that all deployed vehicles 150 will continue to behave in the commanded mode in a moving path that follows the primary 110. Note that for each of these behaviors, the vehicle attempts to converge to, and follow the desired spatial path at a constant speed, without any temporal constraints as a conceptual demonstration—in the future this can be extended to include time-parameterization in order to synchronize the positions of multiple vehicles.

With these operational modes, multiple vehicles may be commanded to collect data using different behaviors relative to an operator with minimal configuration in the field. The primary power of this approach is scalability: any number of vehicles can be added, each with different parameterized offsets specified in the look-up table to perform mission specific sampling. By recording source position and logging the relative position of the primary estimated by each vehicle, we can accurately estimate the trajectories of all AUVs in an absolute (global) frame of reference in post processing, either on-deck when all AUVs have returned and data downloaded, or after the fact. An advantage of this technique is ease of configuration and intuitive operation: the user need only specify offset parameters for each behavior per vehicle in a single look-up table to get easily understood primary-centric multi-AUV operations.

An example application is in oceanographic sampling of fronts. An operator could deploy many AUVs in a single area, at which point they command a ‘Relative Line’ behavior, with vehicle tracks crossing the front. When the operator determines that the front has moved, they change modes so that vehicles enter the ‘Relative Loiter’ behavior to follow and circle the beacon, and moves the vessel to the new front location before switching the mode back to the ‘Relative Line’ behavior. Upon mission completion, ‘Return and Surface’ brings all vehicles back to the operator. If the beacon is housed on an ASV or conventional AUV outfitted with a DVL-aided INS, the operator can command the beacon remotely via a single acoustic or radio modem installed on this intelligent primary vehicle. Collected data can be globally geo-referenced by using the beacon position from GPS (in the ASV case) or DVL-aided INS (for a primary AUV) to correct AUV fleet trajectories in post processing.

Experiments were conducted to demonstrate these principles in the Charles River in Cambridge Mass. A beacon was used to command three submerged AUVs in-situ and in real-time based on broadcast waveform. Three Bluefin SandShark AUVs named Platypus, Quokka and Wombat, were used in these experiments. The experiments used a custom acoustic beacon that consisted of an acoustic source box with corresponding underwater speaker (collectively the primary).

SandShark Autonomous Underwater Vehicle. Production-model Bluefin SandShark AUVs from General Dynamics were used for testing acoustics and autonomy in experiments. Unlike conventional AUVs which typically navigate using an expensive DVL-aided INS, the SandShark AUV is a miniature, low-cost alternative that navigates by default via dead-reckoning using propeller speed and vehicle attitude from a MEMS IMU; as such, its positional error without external acoustic aiding accumulates at a rate of about 3 m/min, unless on the surface where it receives GPS. The manufacturer provides a tail section with thruster and control fins, including sensors (IMU and GPS) and actuators required for basic vehicle control. Users can then add a payload that interfaces to the tail via a cable that includes power and Ethernet.

Vehicle Payload and Configuration. The payloads added to the SandShark vehicles include the piUSBL receiver. This system consists of an external hydrophone array, and a dry bottle containing a DAQ, timing, and autonomy system. The data measured by the pyramidal array (i.e. receivers 152) is collected using a Measurement Computing 1608FSPlus DAQ. A Microsemi CSAC provides a PPS timing signal that triggers the DAQ to record data to the computer in sync with the acoustic transmission by the primary. Collected data is processed on the computer to identify the broadcast waveform and to estimate range and bearing to the primary's acoustic transmitter. The payloads also include a NBOSI temperature/salinity sensor to be used in future oceanographic sensing missions. All data logging, signal processing, and MOOS-IvP autonomy is performed in real-time onboard the secondary AUV. All behavior configurations are tested in simulation that includes AUV dynamics prior to deployment to ensure expected behavior.

Data from the DAQ is processed on the computer to estimate range and bearing to the acoustic beacon as well as the waveform. PPS triggers data collection such that the start of each data sequence corresponds to the transmitter firing. The “most likely” waveform is determined by calculating the maximum of the matched filter with each possible waveform. Beamforming and matched filtering are then performed based on most likely waveform and coupled into particle filtering to estimate range r and bearing γ to the acoustic source from the vehicle. This is fused with vehicle heading h to estimate the relative location of the acoustic source, δx, δy.

### EXAMPLE 4

### Multiple Primaries

In another currently preferred embodiment, a system comprising two primary acoustic sources increases self-localization of secondary vehicles to less than 1 meter accuracy, that is, to self-localization accuracy within one meter. In systems utilizing multiple primary vehicles, each primary transmits different waveforms such that each primary's transmissions can be received by a secondary vehicle and properly timed and interpreted. The inventive localization system described in detail herein applied to a single primary vehicle, is also applicable to embodiments with multiple beacons. In multiple acoustic source embodiments, the controller of the secondary vehicle further determines relative location to all primaries, the likelihood of errors, and determines the best location fit in light of all primary vehicles.

The piOWTT system with multiple primary vehicles is advantageous over currently available LBL systems, in that it requires as few as two acoustic sources (where LBS systems require an array of four sources), and enables real-time, on-board processing, allowing for accurate, constantly updated location information on the secondary vehicle.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is to be understood that the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions. Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on, or executable by, a programmable computer including any combination of any number of the following: a processor, a storage medium readable and/or writable by the processor (including, for example, volatile and non-volatile memory and/or storage elements), an input device, and an output device. The input device and/or the output device form a user interface in some embodiments. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically (i) maintain time-synchronization with the primary system, (ii) develop a range estimate signal from measurements of received signals from the at least two receivers and (iii) develop an azimuth-inclination estimation of likeliest angle-of-arrival of the primary signals, wherein the controller utilizes a plurality of coordinate frames to provide an estimate of secondary system location. Such features can only be performed by computers and other machines and cannot be performed manually or mentally by humans.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a controller, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disk (not shown) or a removable disk or flash memory. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium or other type of user interface. Any data disclosed herein may be implemented, for example, in one or more data structures tangibly stored on a non-transitory computer-readable medium. Embodiments of the invention may store such data in such data structure(s) and read such data from such data structure(s).

It is the intention, therefore, to be limited only as indicated by the scope of the claims appended hereto. Other embodiments will occur to those skilled in the art and are within the following claims.

What is claimed is:

1. A localization system for at least one vehicle capable of submergence and movement within a liquid body, comprising:
a primary system including a first positioning module configured to determine a location of the primary system, a signal generation and timing unit that generates periodic timed primary signals, and a submersible transmitter configured to transmit the primary signals through the liquid body; and
at least one secondary system that is carried by the vehicle and includes:
at least two receivers to receive said primary signals; and
a controller that (i) maintains time-synchronization with the primary system, (ii) develops a range estimate signal from measurements of received signals from the at least two receivers and (iii) develops an azimuth-inclination estimation of likeliest angle-of-arrival of the primary signals, wherein the controller utilizes a plurality of coordinate frames to provide an estimate of secondary system location.

2. The system of claim 1, wherein the estimate of secondary system location is relative to the location of the primary system.

3. The system of claim 1, wherein the controller applies a beamformer to a first plurality of look-angles and the received primary signal, each look-angle representing a combination of azimuth and inclination vectors, generating a first plurality of corresponding outputs, each output having a power, and the controller selects the output with the maximum power, representing approximately the azimuth and inclination between the primary system and secondary system.

4. The system of claim 3, wherein the first plurality of look-angles is constrained to a second plurality of look-angles by the controller applying a particle filter, said second plurality having a smaller number of look-angles than the number of look-angles in the first plurality.

5. The system of claim 3, wherein the controller further comprises a spatial filter stored in a computer-readable storage medium, said spatial filter comprising phase-shifts associated with a regular grid of a third plurality of look-angles.

6. The system of claim 5, wherein the secondary system further comprises a second positioning module, configured to determine the location of the secondary system, and the controller re-initiates the first plurality of look-angles upon said second positioning module determining the location of the secondary system.

7. The system of claim 5, wherein the first plurality of look-angles is converted to a fourth plurality of look-angles based on a motion model, the motion model estimating vehicle speed and yaw.

8. The system of claim 7, wherein the fourth plurality of look-angles is constrained to a fifth plurality of look angles by the controller applying a particle filter, said fifth plurality having a smaller number of look-angles than the number of look-angles in the fourth plurality.

9. The system of claim 1, wherein said plurality of coordinate frames includes at least two of a body-fixed frame, a vehicle-carried frame, and a local-level frame.

10. The system of claim 1, wherein the controller conducts phased-array beamforming by iterating various azimuth-inclination look-angles, using array geometry to apply time-delay phase shifts to the received signals, and summing the time-delayed signals to determine a maximum response where the receiver/hydrophone signals are in phase and add constructively.

11. The system of claim 10, wherein phase shifts associated with each look-angle are precomputed and stored in a computer-readable storage medium for use by the controller.

12. The system of claim 1, wherein the primary signals are generated to further include information encoding at least one of primary system location, and at least one command to the at least one secondary system.

13. The system of claim 1, wherein the signal generation and timing unit further generates periodic secondary signals, said secondary signals comprising information encoding at least one of primary system location, and at least one command to the at least one secondary system.

14. The system of claim 1, further comprising at least a second primary system, said second primary system comprising a third positioning module configured to determine a location of said second primary system, a second signal generation and timing unit that generates periodic timed second primary signals, and a second submersible transmitter to transmit the second primary signals through the liquid body; wherein said primary signals have a first waveform and the second primary signals have a second waveform and wherein said at least two receivers receive said second primary signals.

15. The system of claim 14, wherein the at least one secondary vehicle is configured to achieve self-localization to within one meter accuracy.

16. A localization system for a plurality of vehicles within a liquid body, comprising:
an acoustic source system including a positioning module, a signal generation and timing unit that generates periodic timed primary acoustic signals, and an underwater acoustic transmitter to transmit the primary acoustic signals through the liquid body; and
a plurality of vehicles, each vehicle including (i) a hydrophone array to receive the primary acoustic signals, (ii) a data acquisition module that maintains time-synchronization with the acoustic source system to trigger periodic recordings from the hydrophone array, (iii) a beamforming and matched filtering module that develops a range estimate signal from measurements of received acoustic signals from each hydrophone in the hydrophone array and develops an azimuth-inclination estimation of likeliest angle-of arrival of the primary acoustic signals, and (iv) a particle filtering module utilizing a plurality of coordinate frames to provide an estimate of vehicle location.

17. A method for locating at least one submersible vehicle, comprising the steps of:
selecting at least one primary system including a first positioning module, a signal generation and timing unit that generates periodic timed primary signals, and a submersible transmitter configured to transmit the primary signals;
selecting the at least one submersible vehicle to carry at least one secondary system including at least two receivers to receive the primary signals, and a controller;
obtaining the location of the at least one primary system utilizing the first positioning module;
sending out at least one primary signal from the at least one primary system;
maintaining time-synchronization between the at least one primary system and the at least one secondary system;
receiving the at least one primary signal utilizing the at least two receivers of the at least one secondary system;
developing an azimuth-inclination estimation of likeliest angle-of arrival of the received primary signal; and
using a plurality of coordinate frames to estimate range and secondary location relative to the at least one primary system.

18. The method of claim 17 further comprising the step of performing at least a first autonomous behavior by the submersible vehicle relative to the primary system.

19. The method of claim 18 wherein the primary signals are generated to further include information encoding at least one of primary system location, and at least one command to the at least one secondary system and wherein the at least one secondary system changes to an at least a second autonomous behavior.

20. The method of claim 17 further comprising the step of returning said at least one secondary system to the location of the primary system.
